(19) United States
(12) Patent Application Publication
(10) Pub. No.: US 2026/0242652 A1
(43) Pub. Date: Aug. 20, 2026

(54) PHASE CHANGE MATERIAL PRODUCTION KIT AND USE THEREOF

(71) Applicant: SUNAMP LIMITED, Edinburgh East Lothian (GB)

(72) Inventors: Gylen ODLING, Edinburgh East Lothian (GB); David OLIVER, Edinburgh East Lothian (GB); Andrew BISSELL, Edinburgh East Lothian (GB)

(21) Appl. No.: 18/997,393

(22) PCT Filed: Jul. 27, 2023
(86) PCT No.: PCT/GB2023/051989

§ 371 Date: Jan. 21, 2025

(30) Foreign Application Priority Data
Jul. 27, 2022 (GB) 2210942.5

(51) Int. Cl. C09K 5/06

(52) U.S. Cl. CPC C09K 5/063

(57) ABSTRACT

There is herein described a kit for producing PCMs comprising one or more additives. There is also described a method of manufacturing a PCM, the method comprising using a kit as described herein and a latent heat storage material or precursor thereof. In particular, there is described a kit for producing PCMs comprising one or more additives. There is also 5 described a kit and method of use thereof for producing PCMs which comprises no loose powders, granules and/or flakes.

### FIELD OF THE INVENTION

The present invention relates to phase change materials (PCMs). In particular, the present invention relates to a kit for producing PCMs comprising one or more additives. The present invention also relates to a method of use of the kit. More specifically still, the present invention relates to a kit and method of use thereof for producing PCMs which comprises no loose powders, granules and/or flakes.

### BACKGROUND OF THE INVENTION

PCMs store and release thermal energy in the latent heat associated with melting and crystallisation, where energy is stored and released as the material transitions across the solid/liquid phase boundary.

PCMs are typically chosen for a certain application based on their heats of the phase transition(s), the temperature at which the transition(s) occur, the reliability of the transition(s), and the stability of the PCM to repeat thermal cycles. In addition to these factors, cost, toxicity, compatibility with containment materials and submerged components, and environmental sustainability of PCMs also inform the decision of which PCM to use.

It is common to find that for one or more of the above reasons that PCMs will have some good properties, but also may have some drawbacks which hinder or make impossible their use. For example, a PCM may be cheap and non-toxic, and have a suitable phase transition temperature, but may not thermally cycle reliably. To overcome or alleviate any potential problems, it is common to use various additives to improve the performance of the PCM in some manner for a given application. Two common additives are nucleation agents, used to encourage the PCM to crystallise, and stabilising agents, used to improve the cycle stability of the PCM. Other common additives may be melting point depression agents, anti-corrosion agents, biocides, thickeners and pH modulating agents.

Use of such additives however increases the complexity of the PCM preparation process and may introduce difficulties and/or sources of error when carried out at large scale.

Preparation of PCMs typically requires careful weighing and measuring of the PCM components. In doing so at scale, this may involve manually handling large quantities of various solids and liquids, while maintaining the required degree of accuracy to produce a working PCM.

Preparation of PCMs may also typically involve bulk supply of some components (e.g. the bulk of the PCM aside from the PCM additives, the latent heat storage material), while the PCM additives may be present in a few percent or less.

Often additives will take a solid form, typically as a powder, granule and/or flake.

This is disadvantageous to the accurate, safe, quick, and simple combination of the PCM additive with the other PCM components.

Use of loose solid components (such as powders, granules and/or flakes) may be complicated by a number of factors such as any one of or combination of the following:
loose solids may be difficult or expensive to measure or meter in real time;
loose solids may be hard to transfer from one container to another without losses;
loose solids are often slow to be transferred when carried out accurately;
loose solids may create dusts or may be buoyant in air, creating an inhalation hazard for workers;
transference of loose solids from one container to another, or into the PCM in an accurate manner is typically slow;
some solids may cause a large endothermic effect when added to the PCM, which may be sufficient enough to cause unwanted crystallisation, with the potential to damage equipment or hinder or block the transference of the PCM from one container to another; and/or
the bulk density of a loose solid may be low, leading to relatively high volumetric transport costs.

It is an object of the present invention to obviate or mitigate one or more of the problems described herein.

It is an object of the present invention to provide a kit for PCM manufacture and a method of use thereof.

It is an object of the present invention to provide a kit for PCM manufacture comprising the PCM additives.

It is an object of the present invention to provide a kit for PCM manufacture comprising the PCM additives wherein the PCM additives are in a form which simplifies production of the PCM.

It is an object of the present invention to provide a kit for PCM manufacture comprising the PCM additives, wherein the PCM additives are in a form other than that of a loose solid.

It is an object of the present invention to provide a kit for PCM manufacture comprising the PCM additives where said additives are formed as compressed pieces, melt-cast pieces, and/or are in a liquid state, which may be a suspension.

It is an object of the present invention to provide a kit for PCM manufacture comprising the PCM additives where the inclusion of said additives into the PCM is made simple, deskilled, faster, safer and/or more accurate by the use of the kit.

It is an object of the present invention to provide a method of use of a kit for PCM manufacture, wherein the kit is used in conjunction with a latent heat storage material to produce the PCM.

It is an object of the present invention to provide a method of use of a kit for PCM manufacture, wherein the kit is used in conjunction with a precursor to a latent heat storage material.

It is an object of the present invention to provide a method of use of a kit for PCM manufacture, wherein the kit is used in conjunction with a heat battery apparatus and a latent heat storage material and/or precursor thereof.

### SUMMARY OF THE INVENTION

The present invention relates to a kit for PCM manufacture and method of use thereof.

According to a first aspect of the present invention there is provided a kit for producing a phase change material (PCM), wherein the kit comprises:
one, at least one or a plurality of PCM additive components, wherein:
the one, at least one or a plurality of PCM additive components is in any of the following forms:
   in a compressed form;
   in a melt-cast form;
   and/or
   in a liquid or suspension form.

The kit may comprise a single additive or a plurality of additives.

In embodiments in which the kit comprises a plurality of additives, the PCM additives may be present in the same form or a different form (e.g. some additives may be present as a suspension, while others may be present in a different form, such as in a compressed form. Alternatively, all additives may be present in the same form (e.g. compressed form, melt-cast form, liquid from or suspension form).

The kit may further comprise a latent heat storage material and/or a precursor for a latent heat storage material.

The kit may further comprise a container for combining the at least one PCM additive component and the latent heat storage material or precursor thereof.

The kit may further comprise instructions for use.

The kit may comprise a single component or a plurality of components. Each kit component may comprise a single additive, or a plurality of additives. The kit may comprise a single kit component which itself is comprised of a plurality of additives. The kit may comprise a plurality of components, each comprising a single additive.

When the at least one PCM additive component is present in the kit in a compressed form and/or in a melt-cast form, the PCM additive may be supplied in the kit in the form of one or more pieces, such as a compressed piece and/or a melt-cast piece.

Each compressed piece or melt-cast piece may have a volume of at least about 0.1 cm³. Each compressed piece or melt-cast piece may comprise a single additive or multiple additives. When each piece comprises multiple additives, loose solids the multiple additives may be blended or otherwise mixed prior to forming the piece. Alternatively, loose solids of each additive may be layered (e.g. inside a compression die or melt-cast mould) prior to forming the piece.

Each compressed piece or melt-cast piece may have a volume of at least about 0.1 cm³.

Each compressed piece or melt-cast piece may have a volume of: at least about 1 cm³; at least about 100 cm³; at least about 500 cm³; at least about 1,000 cm³; at least about 5,000 cm³; or at least about 10,000 cm³, depending on the size of the preparation and relative loading of the PCM additive required. For ease of handling, it is preferred that such additive pieces are around 1-1000 cm³ in volume.

Each additive piece may have a volume from: about 1 cm³ to about 900 cm³; or from about 1 cm³ to about 500 cm³; or from about 1 cm³ to about 300 cm³; or from about 1 cm³ to about 100 cm³; or from about 1 cm³ to about 50 cm³; or from about 1 cm³ to about 20 cm³; or from about 10 cm³ to about 50 cm³; or from about 25 cm³ to about 50 cm³; or from about 100 cm³ to about 500 cm³; or from about 200 cm³ to about 400 cm³; or from about 500 cm³ to about 1000 cm³; or from about 600 cm³ to about 800 cm³; or from about 700 cm³ to about 900 cm³.

Different kit components may have different piece sizes. Multiples of the same additive piece may have approximately the size/volume. Thus, the use of the kit component(s) is simplified as each piece can be considered to be equal or near equal in mass and volume to any other piece comprising that kit component, and can be used without exact measurement and instead simply counted.

The compressed solid and/or melt-cast additive(s) may be compressed and/or melt cast in one or more of the following geometries:
spherical;
cuboidal;
ellipsoidal;
cylindrical;
conical;
star;
any pyramidal shape;
any sheet like geometry;
any bar like geometry; and/or any bipyramidal shape.

The kit may be configured to be used by combination of the kit component or components with a latent heat storage material or precursor thereof to produce the phase change material (PCM).

The PCM additive(s) may be present in the kit in a liquid form.

The PCM additive(s) may be liquids at ambient conditions (e.g. at atmospheric pressure and room temperature). The PCM additive(s) may be present in liquid form in a solution (liquid in liquid or solid in liquid) or suspension (e.g. solid in liquid).

The PCM additive component(s) may be present in the liquid additive kit component at or above their solubility limit.

The PCM additive component(s) may initially be solid and become liquid by the application of heat before use.

Within the context of this disclosure, a suspension may be defined as a liquid in which a solid is dispersed, which may be evenly or homogeneously dispersed, or inhomogeneously dispersed (i.e. solid materials having an uneven distribution within the liquid).

In a further aspect of the present invention there is provided a PCM comprising a kit of the first aspect of the invention; and a latent heat storage material or precursor thereof.

The latent heat storage material of any aspect of the invention may be a combination of one or more of the following: a salt; salt hydrate; salt-water eutectic or organic material.

A precursor to the latent heat storage material may be any material which may be transformed into the latent heat storage material. The latent heat storage material precursor may form the latent heat storage material by reaction, which may be a neutralisation reaction, concentration, dilution and/or dissolution. At least two precursors may be needed to form the latent heat storage material.

The kit may be configured to be used by combining said kit with one or more precursors of the latent heat storage material. These kit and combined precursors of the latent heat storage material may then be configured to be combined with further precursors to form the PCM.

The latent heat storage material or precursor thereof may be configured to be combined with the kit component(s) of the invention in its liquid phase (e.g. molten state). The latent heat storage material may be in its liquid state when the kit is used. The kit components may also be liquid.

The PCM additive component may be any one or more of the following:
nucleation agents;
stabilisation agents;
melting point depression agents;
anti-corrosion agents;
rheology modification agents;
pH modification agents;
thermal conductivity enhancing agents; and/or
biocides.

Said PCM additive component(s) may be supplied in the kit in a compressed form, in a melt cast form, and/or as a liquid or suspension in a liquid.

The crystallisation promotion additive may also be known as nucleation agent. The stabilisation agent may be a polymer, a surfactant, a thickening agent and the like.

The melting point depression agent may be an impurity additive.

The thermal conductivity enhancing agent may be a carbonaceous material (e.g. graphite, graphene), other planar material (e.g. boron nitride), and/or other nanomaterials (e.g. nanoparticles, rods, tubes).

The pH modification/modulation agent may be an acid, a bases and/or a buffer.

More specifically, the PCM additive may be one or more components selected from any one or more of the following: a polymer; a monomer; a polymerisation initiator; a surfactant; a salt; a salt hydrate; an acid; a base; an oxide; a carbide; a silicate; a carbonaceous material; an organic material; a heterocycle; an oil and/or a wax.

The PCM additive(s) is present in the kit in a compressed form, in a melt-cast form, and/or as a liquid or suspension in a liquid.

The PCM additive components may comprise one or more additives in the same form or in different forms. Where there is more than one PCM additive, the PCM additives may be mixed to form a kit component (e.g. a piece or a liquid comprising a mixture of additives), or each additive may be provided separately as an individual kit component, or the kit may comprise at least one kit component having a mixture of additives and at least one kit component having a single additive. The kit components may be in the same form or in different forms in the kit.

Nucleation agents may be selected from (but not limited to) any of one or more of the following: strontium nitrate; magnesium nitrate; disodium phosphate; strontium chloride; sodium borate and/or any hydrate form(s) thereof. Nucleation agents may also be selected from (but not limited to) any combination of one or more of the following: silver iodide; silicon dioxide; silicon carbide; titanium dioxide; aluminium oxide; bismuth oxide; zinc oxide; iron oxide; copper oxide; vermiculite or other phyllosilicate materials; and/or talc.

Nucleation agents may comprise more than 0.1 wt. %, more than 0.5 wt. %, more than 1 wt. %, more than 5 wt. % or more than 10 wt. % of the final PCM composition.

Where present in the PCM preparation kit, nucleation agents may comprise at least 5 wt. %, at least 10 wt. %, at least 20 wt. %, at least 30 wt. %, at least 40 wt. %, at least 50 wt. %, at least 60 wt. %, at least 70 wt. %, at least 80 wt. %, at least 90 wt. % or about 100 wt. % of the kit component.

Stabilisation agents may be crystal habit modifiers selected from but not limited to any combination of one or more of the following: sodium; lithium; potassium and/or ammonium salts of polyacrylic acid; and/or polymethacrylic acid; polyethylene glycols; and/or polypropylene glycols.

Stabilisation agents may also be thickeners including but not limited to any combination of one or more of the following: sodium carboxymethylcellulose; polyacrylamide; xanthan gum; guar gum; clays such as bentonite, diatomite and kaolinite and/or talc.

Stabilisation agents may comprise more than 0.01 wt. %, more than 0.05 wt. %, more than 0.1 wt. %, more than 0.5 wt. %, more than 1 wt. %, more than 2 wt. %, more than 5 wt. % or more than 10 wt. % of the final PCM composition.

Where present in the PCM preparation kit, stabilisation agents may comprise at least 5 wt. %, at least 10 wt. %, at least 20 wt. %, at least 30 wt. %, at least 40 wt. %, at least 50 wt. %, at least 60 wt. %, at least 70 wt. %, at least 80 wt. %, at least 90 wt. % or about 100 wt. % of the kit component.

Melting point depression agents may be selected from any one or more of the following: magnesium sulfate; lithium nitrate; magnesium nitrate; sodium nitrate; sodium, lithium, potassium and/or ammonium salts of carboxylic acids; sodium bromide; sodium chloride; calcium bromide; calcium chloride; sodium sulfate; strontium bromide; strontium chloride; ammonium chloride; potassium chloride; potassium bromide; magnesium chloride; magnesium bromide and/or lithium sulfate.

Melting point depression agents may comprise more than 1 wt. %, more than 3 wt. %, more than 5 wt. % more than 10 wt. %, more than 15 wt. % or more than 20 wt. % of the final PCM composition.

Where present in the PCM preparation kit, stabilisation agents may comprise at least 5 wt. %, at least 10 wt. %, at least 20 wt. %, at least 30 wt. %, at least 40 wt. %, at least 50 wt. %, at least 60 wt. %, at least 70 wt. %, at least 80 wt. %, at least 90 wt. % or about 100 wt. % of the kit component.

The anti-corrosion agent may be selected from any one or more of the following: benzotriazole and/or alkylaminophosphates.

Anti-corrosion agents may comprise more than 0.0001 wt. %, more than 0.0005 wt. %, more than 0.001 wt. %, more than 0.01 wt. % or more than 0.05 wt. % of the final PCM composition.

Where present in the PCM preparation kit, anti-corrosion agents may comprise at least 0.1 wt. %, at least 0.5 wt. %, at least 1 wt. %, at least 2 wt. %, at least 5 wt. %, at least 10 wt. %, at least 20 wt. %, at least 30 wt. %, at least 40 wt. %, at least 50 wt. %, at least 60 wt. %, at least 70 wt. %, at least 80 wt. %, at least 90 wt. % or about 100 wt. % of the kit component.

The latent heat storage material may be selected from but not limited to any one or more of the following: water; magnesium nitrate hexahydrate; a salt-water eutectic; calcium chloride hexahydrate; sodium acetate trihydrate; calcium nitrate tetrahydrate; methyl laurate; dimethyl adipate; dimethyl succinate; erythritol; trimethylolethane; hexadecanol; tetradecanol; lithium nitrate trihydrate; calcium bromide hexahydrate; strontium bromide hexahydrate; strontium chloride hexahydrate; sodium sulfate decahydrate; disodium phosphate dodecahydrate; sodium carbonate decahydrate; sodium, lithium; potassium and/or ammonium tetrafluoroborates; tetrabutylammonium salt semi-clathrate hydrates; and/or tetraisopropylammonium salt semi-clathrate hydrates.

The latent heat storage material may comprise the bulk of the final PCM composition.

The latent heat storage material may comprise more than 20 wt. %, more than 40 wt. %, more than 50 wt. %, more than 60 wt. %, more than 70 wt. %, more than 80 wt. %, more than 90 wt. % or more than 99 wt. % of the final PCM composition.

The thermal conductivity enhancement agent may be selected from, but not limited to: expanded natural graphite; graphene; boron nitride and/or graphitic carbon nitride.

Thermal conductivity enhancing agents may comprise more than 1 wt. %, more than 3 wt. %, more than 5 wt. %, or more than 10 wt. % of the final PCM composition.

Where present in the PCM preparation kit, thermal conductivity enhancing agents may comprise at least 5 wt. %, at least 10 wt. %, at least 20 wt. %, at least 30 wt. %, at least 40 wt. %, at least 50 wt. %, at least 60 wt. %, at least 70 wt. %, at least 80 wt. %, at least 90 wt. % or about 100 wt. % of the kit component.

The pH modification agent may be selected from any one or more of the following: acetic acid; glycolic acid; or other carboxylic acid; sulfuric acid; nitric acid; hydrochloric acid; hydroiodic acid; hydrobromic acid; hydrofluoric acid; fluoboric acid; sodium hydroxide; lithium hydroxide; potassium hydroxide; magnesium hydroxide and/or calcium hydroxide.

pH modification agents may comprise more than 0.0001 wt. %, more than 0.0005 wt. %, more than 0.001 wt. %, more than 0.005 wt. %, more than 0.01 wt. %, more than 0.1 wt. %, more than 1 wt. % or more than 5 wt. % of the final PCM composition.

Where present in the PCM preparation kit, pH modification agents may comprise at least 0.1 wt. %, at least 0.5 wt. %, at least 1 wt. %, at least 2 wt. %, at least 5 wt. %, at least 10 wt. %, at least 20 wt. %, at least 30 wt. %, at least 40 wt. %, at least 50 wt. %, at least 60 wt. %, at least 70 wt. %, at least 80 wt. %, at least 90 wt. % or about 100 wt. % of the kit component.

PCM additives may comprise up to 100 wt. % of any individual kit component. For example, where the kit component comprises a single PCM additive, the kit component may be entirely comprised of that additive. Thereby a plurality of PCM additives can be present in the kit as separate components which can be combined with the latent heat storage material to give the final PCM composition. Alternatively, a single PCM additive can be present in the kit, and can be combined with the latent heat storage material to give the final PCM composition. A single PCM additive may be present in the kit in more than one form (i.e. liquid, solution, suspension, melt-cast solid and/or compressed solid).

In a preferred embodiment of the present invention, the kit comprises at least two PCM additive components, where at least one component comprises one or more stabilisation agents, and at least one other component comprises one or more nucleation agents.

In a further preferred embodiment of the present invention, the kit comprises a single additive component comprised of at least one stabilisation agent and at least one nucleation agent.

In a further preferred embodiment of the present invention, the kit comprises two components, a stabilisation agent in a liquid form, and a nucleation agent in a compressed and/or melt-cast form.

In a further preferred embodiment of the present invention, the kit comprises an additive component which comprises one or more nucleation agents and/or one or more stabilisation agent and a portion of the latent heat storage material.

In a further preferred embodiment of the present invention, the kit comprises a single component which comprises one or more biocides, one or more pH modification agents and/or one or more anti-corrosion agents.

There is also disclosed herein a method for producing compressed PCM additive pieces, melt-cast pieces, and liquified additive components for inclusion in the kit.

The PCM additive(s) may be formed into a compressed form (e.g. compressed piece) by disposing loose solid additive in a container (e.g. a compressive die) and applying pressure to said container. The internal size and volume of the container determines the size and volume of the PCM additive piece.

The PCM additive may be prepared in a compressed form (e.g. a compressed piece) by applying pressure to the PCM additive in loose solid form. The pressure may be at least about 1 MPa, at least about 2.5 MPa, at least about 5 MP, at least about 25 MPa, at least about 100 MPa, or at least about 250 MPa.

Where rapid dispersion of the compressed solid additive(s) into the latent heat storage material, low pressures (i.e. about 1 MPa to about 25 MPa) may be used. Where slower dispersion of the solid material into the latent heat storage material is preferred, pressures of at least about 25 MPa may be applied.

Compression may be applied uni-axially (i.e. along a single axis), or may be applied along multiple axes to produce the compressed piece. For example, compression may be applied in 2, 3 or more axes. The compression may be applied in an isotropic or anisotropic manner.

A method of preparing a compressed form piece of additive for the kit of the invention comprises: arranging a loose powder comprising one or more additive(s) within a pressure rated die and applying a compressive force along at least one axis.

In some embodiments the method comprises applying a compressive form along two, three, or four axes. The method may further comprise removing the PCM additive piece from the die.

The PCM additive(s) may be formed into a melt-cast form by first melting the PCM additive material or materials, disposing the molten additive material(s) in a mould or surface, and allowing the PCM additive material(s) to cool and solidify in the mould or surface to give one or more piece(s).

The method may comprise passively cooling the molten additives or actively cooling the molten additives to solidify the material, giving a cast piece.

When the melt-cast piece comprises a mixture of additive materials, the method may comprise:
combining the loose solid forms of the PCM additive materials;
optionally mixing;
heating the PCM additives to at least the melting point of one of the PCM additive materials;
optionally mixing; and
cooling the PCM additive or additive composite to solidify.

Melting the PCM additive material or materials may be achieved by heating the material(s) to a temperature above their melting point. Active cooling may be performed by any suitable means, such as with a cold plate, cooling gas (e.g. air) or liquid passed over or in the vicinity of the mould.

The PCM additive(s) may be present in the kit in a liquid form. The PCM additive(s) may be liquefied by dissolution and/or suspension. Where a liquid, solution or suspension of an additive is required, a solvent such as water, oil or an organic or ionic liquid may be used.

Where a plurality of additives is present in the kit, one or more additives may be made liquified by dissolving or suspending in one or more other additives which are liquid in nature. A liquid polymer additive may be used as a medium in which a loose solid additive may be dissolved and/or suspended. An additive may be in a molten and/or subcooled state within which other loose solid additives may be dissolved and/or suspended. These mixtures or suspensions may comprise a kit component.

The kit may comprise at least one PCM additive(s) as disclosed herein and a latent heat storage material or precursor thereof, wherein the at least one additive is present in a higher concentration in the latent heat storage material or precursor than that required concentration in the PCM to be produced by use of the kit. In this scenario, the kit component is configured to be used by dilution of the kit component with the latent heat storage material, or precursor thereof.

Thus, the combination of the kit component(s) with the latent heat storage material may be a dilution process. A kit component with a relatively high concentration of additive (e.g. more than that which is required in the final PCM composition to be made on using the kit) may be provided in the kit.

The kit may be configured to provide a PCM with the required concentration of an additive for said PCM upon combination of the PCM additive component of the kit with a component comprising a latent heat storage material or precursor thereof.

The process of combining kit component comprising the latent heat material or precursor with the kit component comprising the PCM additive effectively dilutes the concentration of the PCM additive in the final PCM composition.

The PCM additive(s) forming the kit component(s) may be blended with latent heat storage material or precursor thereof in a solid form and compressed into a piece which comprises a kit component.

For this process, a pressure of at least about 1 MPa, at least about 2.5 MPa, at least about 5 MPa, at least about 25 MPa, at least about 100 MPa or at least about 250 MPa may be used to for the PCM additive-latent heat storage material piece(s).

The PCM additive content of the compressed piece may be higher than that required in the final PCM composition, such that when the kit is used, the kit component is diluted with the latent heat storage material, bringing the concentration of the PCM additive(s) to the required level in the final PCM composition.

The PCM additive(s) forming the kit component(s) may be blended with the latent heat storage material or precursor thereof and melt-cast into a piece which comprises a kit component. This may be achieved by heating the PCM additive(s) and/or the latent heat storage material to a temperature sufficient to melt either one or a plurality of the PCM additive(s) and/or the latent heat storage material and combining the materials into a single liquid or suspension. The liquid or suspension may then be cooled to solidify into one or a plurality of pieces which comprise the kit component. The PCM additive content of the melt-cast piece is higher than that required in the final PCM composition, such that when the kit is used, the kit component is diluted with the latent heat storage material, bringing the concentration of the PCM additive(s) to the required level in the final PCM composition.

The PCM additive(s) forming the kit component may be dissolved or suspended in the latent heat storage material in a liquid form. The PCM additive(s) forming the kit component may be dissolved or suspended in the latent heat storage material in a concentration higher than that required in the final PCM composition, and then the kit component used by combination with the latent heat storage material to bring the concentration of the PCM additive down to the required level.

Thus the kit component(s), where they are blended with the latent heat storage material as a composite compressed and/or melt-cast piece, or are dissolved or suspended in the latent heat storage material, may be considered to be an additive concentrate, or additive concentrated form of the PCM which is to be produced by the use of the kit. Herein an additive concentrate is defined as a component which has a higher additive concentration which can be diluted with the latent heat storage material to produce the PCM.

The kit components may be at least 2×, at least 5×, at least 10×, at least 50×, at least 100×, at least 200×, or at least 500× more concentrated within the kit component than is required in the final PCM composition.

The latent heat storage material may be used to produce at least a 1 in 2 dilution, at least a 1 in 5 dilution, at least a 1 in 10 dilution, at least a 1 in 50 dilution, at least a 1 in 100 dilution, at least a 1 in 200 dilution, or at least a 1 in 500 dilution factor to produce the final PCM.

One or more latent heat storage material precursor(s) may also be used to provide such a dilution factor.

According to a further aspect of the present invention there is provided a method of manufacturing a PCM, the method comprising providing a kit comprising:
at least one PCM additive component, wherein
   the PCM additive component is:
      in a compressed form;
      in a melt-cast form;
      and/or
      in a liquid or suspension form; and
   providing a latent heat storage material or a latent heat storage material precursor; and
   combining the kit components with the latent heat storage material or latent heat storage material precursor.

The kit may be used by combining the kit component or components with a latent heat storage material.

Combining the kit (or kit components) and the latent heat storage material may comprise dispersing the components in the latent heat storage material by any suitable means. For example, the kit component(s) dispersed in the latent heat storage material (e.g. molten latent heat storage material, or in other words latent heat storage material in liquid phase) by agitation, melting, abrasion, dissolution, dilution, gas evolution, phase transition, photochemical degradation or combination thereof. The latent heat storage material may be in the liquid phase, e.g. is a molten latent heat storage material.

The method may comprise heating the latent heat storage material above its melting point to provide the latent heat storage material in liquid phase. The method may comprise heating the latent heat storage material and the kit component during the mixing step. The method may comprise mixing or stirring the combined latent heat storage material and kit additive components after combining. The latent heat storage material and kit components may be combined by heating and mixing simultaneously.

The latent heat storage material precursor or precursors may comprise water, and/or one or more acid or base which may be configured to be reacted with the corresponding base or acid respectively to give a salt which comprises the latent heat storage material.

The method may comprise adding the kit component(s) to the water as a latent heat storage material precursor, then adding an anhydrous salt and/or salt of a lower hydrate than that which is required in the final PCM to the mixture of kit components and water. This may result in the formation of the PCM from the precursor water which is combined with the kit component(s) and a solid (e.g. a salt and/or salt hydrate) to give the final PCM.

The method may comprise adding the kit component(s) to an acid (e.g. an acid in liquid form) as latent heat storage material precursor then adding a base to the mixture of kit component(s) and acid. This may result in the formation of the PCM form the precursor acid which is combined with the kit component(s) and a base, to give the final PCM.

The method may comprise adding the kit component(s) to a base as latent heat storage material precursor then adding an acid to the mixture of kit component(s) and base. This may result in the formation of the PCM form the precursor base which is combined with the kit component(s) and a base, to give the final PCM.

In a further aspect there is provided a method of manufacturing a PCM, the method comprising combining a component or components of a kit as described herein with other PCM components (e.g. the latent heat storage material) within a thermal energy storage device.

A thermal energy storage device may comprise one or more containers, within which may be any one of or combination of the following:
one or more heat exchangers;
one or more heat sources;
one or more sources of cooling; and/or
one or more ports via which material (e.g. additives, latent heat storage material, precursors, PCM) may be added or removed from the device.

A thermal energy storage device may also comprise thermal insulation, sensors and control electronics and/or means of mixing the PCM.

A thermal energy storage device may also comprise an arrangement for adding materials to the container which comprises said device. This may be a funnel, pipe, canula, port or other means, which may be removable from the device after use. Said means for adding materials to the thermal energy storage device container may also be a housing within which the kit components may be placed during preparation.

The method of manufacturing a PCM as disclosed herein may comprise locating the kit component(s) within the thermal energy storage device and then adding of the remaining PCM component(s). Herein the remaining kit component(s) may comprise the latent heat storage material.

The kit may also be used by combining the kit components with the other PCM components (e.g. the latent heat storage material) within a thermal energy storage device which comprises internal componentry (e.g. pipework, one or more heat exchanger(s), heating/cooling devices).

The method may comprise locating the kit component(s) within the thermal energy storage device and in contact with one or more heat exchanger supplying heat and/or one or more heat source within the thermal energy storage device. Locating the kit component(s) in contact with one or more heat source may enable the heat source heat the kit component(s) before and/or during the addition of the remaining PCM component(s) (e.g. latent heat storage material). The latent heat storage material may then be combined with the kit component(s) as a liquid (i.e. in a molten state).

The kit components may be preferentially arranged such that the latent heat storage material or precursor thereof is added onto the kit components (i.e. impinges thereon as it is added) during the combining of the materials and generate a PCM within the thermal energy storage device.

The kit may also be used by combining the kit components with one or more precursors to the other PCM components, such as a precursor to the latent heat storage material. The precursor may be configured to be subsequently transformed into the PCM, optionally by reaction with one or more of the components of the kit.

As disclosed in the examples hereinafter, the inventors have found that such a kit can be used to simplify the production of a bulk PCM, reduce the required metering, reduce material volumes, shipping volumes, make quicker the production, aid in the ease of dosing of each component, make safer the production process and avoid endothermic effects on the PCM production.

### DESCRIPTION OF THE FIGURES

FIG. 1 shows a process of manufacturing and using a kit as described herein.

FIG. 2 shows a method of forming a compressed additive component piece within a die apparatus (201) wherein the loose powder form of one or more additive(s) (202) is located within the die and compressed in the direction indicated by (203) to give a compressed additive piece (204) which may be removed from the die and form a part or whole of a kit for PCM production.

FIG. 3 shows a method of forming a melt-cast additive component piece within a mould (301), by pouring the molten additive(s) (302) into said mould and allowing it to solidify, forming a cast additive piece (303) which may be then removed from the mould and form a part or whole of a kit for PCM production.

FIG. 4 shows a method of manufacturing a PCM using a kit component within a heat battery apparatus comprising a container (401) and an example internal apparatus (402) which may be a heat exchanger or other pipework, wherein the kit component locations (403, 404, 405, 406, 407, 408) are denoted and the flow of latent heat storage material and/or precursor(s) thereof (409) is also denoted, resulting it the formation of the PCM (410) within the heat battery.

FIG. 5 shows a method of manufacture of a PCM using one or more kit component(s) within a heat battery apparatus comprising a container (501) and an example internal apparatus (502) which may be a heat exchanger or other pipework, wherein the kit component(s) (503) are located in the path of the flow of a latent heat storage material or precursor thereof (504), resulting in the formation of the PCM (506) within the heat battery.

### DETAILED DESCRIPTION

The present invention relates to the production of phase change materials (PCMs) comprised of a latent heat storage material and one or more additives(s) which improve some aspect of the latent heat storage material performance. While some latent heat storage materials may require no modification for their use as thermal energy storage media, it is often the case that additives improve on the latent heat storage material properties and/or overcome a negative aspect of the material.

Issues faced by latent heat storage materials include but are not limited to:
poor nucleation;
slow crystal growth kinetics;
poor cycle stability;
corrosiveness;
inopportune phase transition temperature; and/or
thermally insulative properties.

As such, it is common to use additives to overcome or alleviate issues observed in latent heat storage materials and thereby enable or improve their suitability for application.

It is common to use nucleation agents where a latent heat storage material exhibits subcooling, the phenomenon where the material remains in a metastable liquid state below its phase transition temperature. Furthermore, once nucleated, the growth of a crystal may be slow, limiting the thermal power achievable by the system. Crystallisation promoting agent additives may be applied to improve the thermal power of a system.

It is also a key parameter of PCMs to be repeatably thermally charged and discharged (i.e. cycled through a phase transition), however many latent heat storage materials exhibit instability when this process is carried out. Additives such as polymers, surfactants and thickening agents may be used to improve cycle stability, hindering the decomposition or segregation of the PCM and allowing long term use.

PCMs typically exhibit a phase transition at distinct temperatures, absorbing and releasing heat at these temperatures. Where a phase transition temperature of a latent heat storage materials is inopportune for a chosen application, the transition temperature can be tuned by the addition of an impurity additive, generally referred to as a melting point depression additive.

Latent heat storage materials may also be corrosive to one or more of the system containment materials and/or any other internal components which are in contact with the PCM. Where corrosion is found to be an issue, anti-corrosion agents may be included in the PCM mixture to alleviate the problem.

Latent heat storage materials may also have a low thermal conductivity, otherwise known as being thermally insulative, and thus be unable to be melted and frozen rapidly or with high power. Additives such as carbonaceous materials (e.g. graphite, graphene), other planar materials (e.g. boron nitride) and/or other nanomaterials (e.g. nanoparticles, rods, tubes) may be used as additives to improve the thermal conductivity of the PCM.

The pH of a latent heat storage material may be disadvantageous. Materials at extremes of pH may be difficult to handle, and pH must be carefully tuned to ensure that all materials with which the PCM is in contact are stable (i.e. do not corrode or otherwise degrade). pH modulating additives such as acids, bases and buffers may be used as additives to produce a PCM with a pH tuned to a certain value.

Some latent heat storage materials may be a medium in which microbes can propagate. In such cases, it may be necessary to use a biocidal additive to control the growth of said microbes.

Furthermore, a plurality of additives of the types listed, and any others deemed necessary for the PCMs performance, may be used together.

Thus, additives commonly used in PCMs include any one or more of the following:
nucleation agents;
stabilisation agents;
melting point depression agents;
anti-corrosion agents;
rheology modification agents;
pH modification agents;
thermal conductivity enhancing agents; and/or
biocides.

Often, these additives are loose solids in the form of powders, granules and/or flakes under standard temperature and pressure conditions. However, this is disadvantageous for the PCM preparation, as these forms of solid are typically harder to work with at scale and may pose a risk to workers.

Loose solids can be difficult or expensive to measure or meter in real time. Measuring solids to an acceptable degree of accuracy, particularly for an additive which may be present in a small proportion of the whole PCM, is difficult, slow and/or expensive. Quickening the production of a PCM is advantageous, as less energy is required to overcome heat loss if the process is fast. Quick addition of additives is therefore advantageous.

Loose solids are typically hard to transfer from one container to another, and often are carried out manually, resulting in a high volume of heavy lifting for operators.

Loose solids may create dusts or may be buoyant in air, creating an inhalation hazard for workers. They may also cause splashing when introduced into the PCM mixture, which may be a further hazard for operators, particularly when producing a very hot or cold PCM, or a PCM which may have toxic, harmful or irritating effects.

Furthermore, the transference of loose solids from one container to another, or into the PCM in an accurate manner is typically slow, and is typically measured gravimetrically, requiring repeated offline measurements slowing the process further.

Some solids may cause a large endothermic effect when added to the PCM. Where an additive is dissolved in the PCM, energy may pass from the PCM to the PCM additive to break the PCM additives lattice structure, cooling the PCM. This cooling effect may be sufficient enough to cause unwanted crystallisation, with the potential to damage equipment or hinder or block the transference of the PCM from one container to another.

In transporting materials for PCM production, it is inefficient to use loose solids, as much of the volume is taken up by voids between particles. Thus, transport costs are higher for loose solids than those which have been compacted or otherwise concentrated in volume.

Thus, it is beneficial for the preparation process of a PCM to avoid the use of loose solids where possible.

The present invention describes a kit for producing/manufacturing a phase change material (PCM), the kit comprising an additive in a compressed form, a melt-cast form, and/or a liquid form or a suspension form. Therefore, the present invention describes a kit for producing/manufacturing a PCM, wherein the kit does not comprise loose solid additives. In other words, the use of loose solid additives is avoided in the kit of the invention by their compression into form stable pieces, their formation into form stable pieces by melt-casting and/or their dissolution or suspension in a liquid to provide a liquid form. The kit may further comprise a latent heat storage material and/or a precursor for a latent heat storage material.

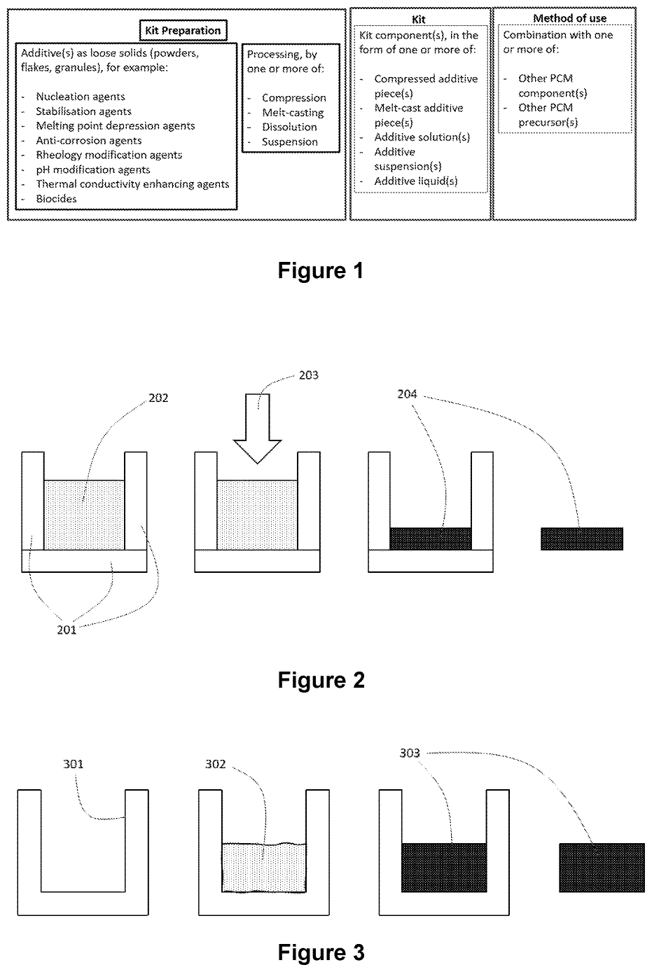

The present invention also describes methods of manufacturing a PCM by combining the kit components with other PCM components (such as, for example, the latent heat storage material) and/or a PCM precursor (such as, for example, water to which a salt is configured to be added to form a salt-water eutectic or salt hydrate). The overall process from formation of the kit to use of the kit is shown schematically in FIG. 1.

Herein a suspension may be defined as a liquid within which a solid is present. The solid may be of a different chemical identity to the liquid (i.e. a solid material within a different liquid material), however the solid may also be of the same chemical identity as the liquid (i.e. a solid form of a material in the liquid form of that same material). The solid may be described as dispersed within the liquid, which may be dispersed in a homogeneous or heterogeneous manner. Homogeneous dispersion may be defined as an even distribution of solid throughout the liquid, while heterogeneous dispersion refers to an uneven distribution of solid throughout the liquid.

The present invention relates to a kit for producing a phase change material (PCM), wherein the kit comprises:
at least one PCM additive component, wherein:
the at least one PCM additive component is:
   in a compressed form;
   in a melt-cast form;
   and/or
   in a liquid or suspension form.

The kit is then configured to be used by combination of the kit components with a latent heat storage material or precursor thereof to produce the PCM.

Herein the final PCM produced is itself comprised of a latent heat storage material and the PCM additives originating from the kit described as part of the present invention. In other words, the PCM without any additives is referred to as the latent heat storage material and becomes the PCM on combination of the latent heat storage material with the PCM additive(s). The final PCM is defined as the end product of the use of the kit in combination with one or more latent heat storage material(s) and/or precursor(s) thereof.

The latent heat storage material may be a salt, salt hydrate, salt-water eutectic, or an organic material. The latent heat storage material is defined herein as the PCM aside from the PCM additives. The PCM is defined as the latent heat storage material with the addition of any additives. A precursor to the latent heat storage material may be any material which may be configured to be transformed into the latent heat storage material.

The latent heat storage material precursor may form the latent heat storage material by reaction (which may be a neutralisation reaction), concentration, dilution and/or dissolution. At least two precursor(s) may be combined to form the latent heat storage material. For example, where the latent heat storage material is a salt, the precursors may be an acid and a base which are configured to react to form said salt. For further example, where the latent heat storage material is a salt hydrate, the precursor may be the salt (or corresponding acid/base precursor) and/or water. Further examples of latent heat storage materials and their precursors are given in Table 1.

TABLE 1

| Latent Heat Storage | |
|---|---|
| Material | Precursor(s) (Two or more of) |
| Sodium acetate | Sodium acetate, sodium bases, acetic acid |
| trihydrate | and/or water |
| Calcium chloride | Calcium chloride, calcium bases, |
| hexahydrate | hydrochloric acid and/or water |
| Calcium bromide | Calcium bromide, calcium bases, |
| hexahydrate | hydrobromic acid and/or water |
| Magnesium nitrate | Magnesium nitrate, magnesium bases, |
| hexahydrate | nitric acid and/or water |
| Calcium nitrate | Calcium nitrate, calcium bases, nitric acid |
| tetrahydrate | and/or water |
| Strontium bromide | Strontium bromide, strontium bases, |
| hexahydrate | hydrobromic acid and/or water |
| Tetrabutylammonium | Tetrabutylammonium acetate, |
| acetate hydrate | tetrabutylammonium bases, acetic acid |
| clathrate | and/or water |
| Tetrabutylammonium | Tetrabutylammonium glycolate, |
| glycolate hydrate | tetrabutylammonium bases, glycolic acid, |
| clathrate | and/or water |
| Tetrabutylammonium | Tetrabutylammonium bromide, |
| bromide hydrate | tetrabutylammonium bases, hydrobromic |
| clathrate | acid and/or water |
| Tetrabutylammonium | Tetrabutylammonium chloride, |
| chloride hydrate | tetrabutylammonium bases, hydrochloric acid |
| clathrate | and/or water |
| Tetrabutylammonium | Tetrabutylammonium propionate, |
| propionate hydrate | tetrabutylammonium bases, propionic acid |
| clathrate | and/or water |
| Sodium sulphate | Sodium sulphate, sodium bases, sulfuric acid |
| decahydrate | and/or water |
| Sodium phosphate | Sodium phosphate, sodium bases, phosphoric |
| dodecahydrate | acid and/or water |
| Lithium nitrate | Lithium nitrate, lithium bases, nitric acid and/or |
| trihydrate | water |
| Sodium nitrate | Sodium bases and/or nitric acid |
| Potassium nitrate | Potassium bases and/or nitric acid |
| Potassium chloride | Potassium bases and/or hydrochloric acid |
| Lithium nitrate | Lithium bases and/or nitric acid |
| Lithium sulphate | Lithium bases and/or sulfuric acid |
| Sodium acetate | Sodium bases and/or acetic acid |
| Sodium chloride | Sodium bases and/or hydrochloric acid |

The kit may comprise a single component or a plurality of components. Each kit component may comprise a single additive, or a plurality of additives. By way of non-limiting example, the kit may comprise a single kit component which itself is comprised of a plurality of additives. By way of further non-limiting example, the kit may comprise a plurality of components, each comprising a single additive.

The PCM additives may be supplied in the kit as discrete items in solid or liquid form. The discrete items may have a pre-measured quantity of PCM additives. Advantageously, providing the PCM additives as discrete items may enable a user to count the number of items to add the required amount to prepare the PCM, thus avoiding the need for weighing or measuring the amount of additive. Within the context of this disclosure, when the PCM additives are in solid form, the discrete items may be named pieces.

The PCM additives may be supplied in the kit in the form of one or more compressed pieces. The PCM additives may be suppled in the kit in the form of one or more melt-cast pieces.

Herein a piece is defined as a quantity of a substance or material forming a single mass or body, and a plurality of such is to be understood according (i.e. a plurality of masses or bodies). The compressed and melt-cast additive pieces which form a part or the whole of the kit may be described as being form stabilised, or having form stability, defined as having the retention of macroscopic shape without a supporting container. This is in contrast to powders, granules or flakes, which would form a pile with a characteristic angle of repose when their supporting container is removed. A form stabilised piece may be handled and used as a single item.

It has been found by the inventors that the benefits of form stabilisation (i.e. by application of compression and/or melt-casting) of the PCM additive(s) into such pieces is lost when the volume of an individual piece falls below about 0.1 cm³, where it begins to behave as a loose powder or granules rather than macroscopic pieces.

To access the benefits of using a macroscopic form stable additive piece, it is therefore necessary to compress/melt-cast the material in pieces which are macroscopic in nature (i.e. far larger in size than a loose powder, flake and/or granule). The inventors have found that form stabilisation of additives as described herein should be at least about 0.1 cm³ in size, and thereby act as individual macroscopic components rather than one or a collection of loose particles. At and above this volume, the method of use of said pieces may be to be physically counted into the PCM preparation vessel, as this size has been found by the inventors to be the minimum required for reliable, predictable, low error loading of the PCM additive.

Thus, the volume of any compressed and/or melt-cast pieces should be greater than about 0.1 cm³ in size.

Compressed and melt-cast solid additive(s) may be formed by compression and/or melt-casting into pieces of any one of or combination of the following: greater than about 1 cm³; greater than about 100 cm³; greater than about 500 cm³; greater than about 1,000 cm³; greater than about 5,000 cm³; and/or greater than about 10,000 cm³, depending on the size of the preparation and relative loading of the PCM additive required. For ease of handling, it is preferred that such additive pieces are about 1-1000 cm³ in volume.

It is disclosed herein that for both compressed and melt cast pieces that the size of the container within which they are formed (i.e. are compressed or are cast in as a melt) determines the size of piece produced. As such, for compressed additive pieces the compressive die used determines the size of piece produced.

The size of the mould in which the PCM additive(s) are cast in from their molten state therefore controls the size of the resulting piece where melt-casting is used. Therefore, the internal size of the die used for compression and/or the mould used for melt-casting is preferably greater than about 0.1 cm³.

It is beneficial to the use of such form stable pieces that the pieces be prepared in a uniform predictable volume, i.e. where a plurality of additive pieces which are the same additive(s) comprise a kit component, said pieces have the same approximate volume and dimensions.

Different kit components may have different piece sizes, according to the required loading in the final PCM composition, however multiples of the same additive piece should preferentially be uniform in size. Thus, the use of the kit component(s) is simplified as each piece can be considered to be equal or near equal in mass and volume to any other piece comprising that kit component, and can be used without exact measurement and instead simply counted.

The compressed solid and/or melt-cast additive(s) may be compressed and/or melt cast in any one or more of the following geometries:
spherical;
cuboidal;
ellipsoidal;
cylindrical;
conical;
star;
any pyramidal shape;
any sheet like geometry;
any bar like geometry; and/or
any bipyramidal shape.

The PCM additives may be present in the kit in a compressed form. Compression has been found by the inventors to be a means by which a form stable piece comprising an additive for PCM production may be created.

The loose solid additive may be compressed using any of the following: above about 1 MPa; above about 2.5 MPa; above about 5 MPa; above about 25 MPa; above about 100 MP; or above about 250 MPa of pressure to form the compressed solid additive present in the kit.

Where rapid dispersion of the compressed solid additive into the latent heat storage material, low pressures (i.e. about 1 MPa to about 25 MPa) may be used. Where slower dispersion of the solid material into the latent heat storage material is preferred, pressures of at least or above 25 MPa may be applied.

MPa can be understood as being equal to 1*10⁶ Pa, or 1*10⁶ Nm⁻².

The compressed additive pieces may comprise a single additive per piece or may comprise a plurality of additives per piece. Combining the loose solids of a plurality of additive materials prior to compression allows compressed pieces to be produced which comprise a plurality of additives. Optionally, the loose solids may be blended by mixing the solid powders before compression. The loose solids may also be layered before compression (i.e. added into the compression die as a series of layers).

A schematic representation of the production of a compressed additive piece is shown in FIG. 2. In FIG. 2 a loose powder of one or more additive(s) (202) is arranged within a pressure rated die (201) and a compressive force is applied with along the axis of the arrow (203). This results in a compressed piece comprising the PCM additive(s) (204) which may be removed from the die and form all or a part of the kit.

Compression may be applied uni-axially (i.e. along a single axis as shown in FIG. 2), or may be applied along multiple axes to produce the compressed piece. For example, compression may be applied in 2, 3 or more axes. The compression may be applied in an isotropic or anisotropic manner. The compression must be applied actively along at least one axis, but may arise from the material being constrained within the die along one or more axes.

The PCM additives may be present in the kit in a melt-cast form. Melt-casting has been found by the inventors to be a means by which a form stable piece comprising an additive for PCM production may be created.

Herein melt-casting is defined as the process by which a piece is prepared by first melting the material(s) and then allowing the materials to cool and solidify in a mould or on a surface to give one or more piece(s).

A general schematic of the process is shown in FIG. 3. In FIG. 3 is shown that, to a mould (301) is added a molten component (302) comprising at least one or a plurality of additives.

This melt (302) then cools either passively or is actively cooled to solidify, giving a cast piece (303) which can be removed from the mould and may form a part or all of a kit for PCM production.

A loose form of a single additive material may be melted by heating to a temperature higher than its melting point, and then poured into a mould and/or onto a surface to cool and solidify. Alternatively, a melt-cast additive piece or pieces may be prepared comprising a plurality of additives.

The process for producing such a piece or pieces is as follows:
combining the loose solid forms of the PCM additive materials;
optionally mixing;
heating the PCM additives to at least the melting point of one of the PCM additive materials;
optionally mixing; and/or
cooling the PCM additive composite to solidify.

To produce melt-cast additive pieces, ambient cooling may be used to solidify the materials into one or more cast piece(s). Active cooling, for example with a cold plate, cooling gas (e.g. air) or liquid passed over or in the vicinity of the mould, may also be used.

Additives which are salts and/or salt hydrates may be preferentially included within the kit in melt-cast forms.

The PCM additives may be present in the kit in a liquid form.

The PCM additives may be liquified by dissolution and/or suspension. Where a liquid or suspension of an additive is required, a solvent such as water, oil or an organic or ionic liquid may be used.

Where a plurality of additives is present in the kit, one or more additives may be made liquified by dissolving or suspending in one or more other additives which are liquid in nature. For non-limiting example, a liquid polymer additive may be used as a medium in which a loose solid additive may be dissolved and/or suspended.

For further non-limiting example, an additive may be in a molten and/or subcooled state within which other loose solid additives may be dissolved and/or suspended. These mixtures or suspensions may comprise a kit component.

The PCM additive component(s) may be present in the liquid additive kit component at or above their solubility limit.

The PCM additive component(s) may initially be solid and become liquid by the application of heat before use.

Disclosed as part of the present invention there is provided a kit for producing a PCM, wherein the kit comprises one or a plurality of PCM additive components. There is also provided one or a plurality of compressed and/or melt-cast solid piece(s) with a volume of at least about 0.1 cm³, wherein any compressed pieces have been subject to a compression of at least about 1 MPa. The one or a plurality of PCM additive components may be in a liquid or suspension form. The PCM additive(s) may be a liquid under ambient conditions of temperature and pressure. The PCM additive(s) may have been dissolved or suspended in a solvent. The one or more additive(s) may have been dissolved in one or more other additives. The one or more additive(s) may have been made liquid by the application of heat.

The PCM additives may be any one or more of the following: polymers; monomers; polymerisation initiators; surfactants; salts; salt hydrates; acids; bases; oxides; carbides; silicates; carbonaceous materials; organics; heterocycles; oils and/or waxes; which are supplied in the kit in a compressed form, a melt-cast form, and/or as a liquid or suspension in a liquid.

Various non-limiting examples of classes of additives, their purposes and their preferred form in the kit as disclosed herein are given in Table 2.

TABLE 2

| Additive | Purpose | Preferred Form in the Kit |
|---|---|---|
| Polymers | Stabilising Agent | Solution, suspension and/or |
| | | compressed and/or melt- |
| | | cast solid |
| Copolymers | Stabilising Agent | Solution, suspension and/or |
| | | compressed and/or melt- |
| | | cast solid |
| Surfactants | Stabilising Agent | Solution, suspension and/or |
| | | compressed and/or melt- |
| | | cast solid |
| Metal oxides | Nucleation Agent | Compressed solid and/or |
| | | suspension |
| Metal carbides | Nucleation Agent | Compressed solid and/or |
| | | suspension |
| Metal silicates | Nucleation Agent | Compressed solid and/or |
| | | suspension |
| Phyllosilicates | Nucleation Agent | Compressed solid and/or |
| | | suspension |
| Thickeners | Stabilising Agent | Solution and/or compressed |
| | | solid |
| Surface coating | Anti-corrosion agent | Solution, suspension and/or |
| agents | | compressed and/or melt- |
| | | cast solid |
| Acids | pH modification | Solution and/or neat |
| | agent | |
| Bases | pH modification | Solution, suspension and/or |
| | agent | compressed and/or melt- |
| | | cast solid |
| Salts | Nucleation agent | Solution, suspension and/or |
| | and/or melting point | compressed and/or melt- |
| | depression agent | cast solid |
| Salt hydrates | Nucleation agent | Solution, suspension and/or |
| | and/or melting point | compressed and/or melt- |
| | depression agent | cast solid |
| 2D nanomaterials | Thermal conductivity | Suspension and/or |
| incl. carbonaceous | enhancing agent | compressed solid |
| materials (e.g. | | |
| graphite) | | |
| Biocides | Microbe control | Solution and/or compressed |
| | | solid |

The kit components may also comprise the latent heat storage material to which they are to be added. Thus, the combination of the kit component(s) with the latent heat storage material becomes a dilution process.

A kit component with a relatively high concentration of additive (e.g. more than that which is required in the final PCM composition to be made on using the kit) may be used, which is then combined with the latent heat storage material when the kit is used, bringing the concentration of the PCM additive(s) down to the required level in the final PCM composition.

The PCM additive(s) forming the kit component(s) may be blended with the latent heat storage material in a solid form and compressed into a piece which comprises a kit component. For this process: a pressure of above about 1 MPa; above about 2.5 MPa; above about 5 MPa; above about 25 MPa; above about 100 MPa or above about 250 MPa may be used to for the PCM additive-latent heat storage material piece(s).

The PCM additive content of the compressed piece is higher than that required in the final PCM composition, such that when the kit is used, the kit component is diluted with the latent heat storage material, bringing the concentration of the PCM additive(s) to the required level in the final PCM composition.

The PCM additive(s) forming the kit component(s) may be blended with the latent heat storage material and melt-cast into a piece which comprises a kit component. This may be achieved by heating the PCM additive(s) and/or the latent heat storage material to a temperature sufficient to melt either one or a plurality of the PCM additive(s) and/or the latent heat storage material and combining the materials into a single liquid or suspension. The liquid or suspension is then cooled to solidify into one or a plurality of pieces which comprise the kit component.

The PCM additive content of the melt-cast piece is higher than that required in the final PCM composition, such that when the kit is used, the kit component is diluted with the latent heat storage material, bringing the concentration of the PCM additive(s) to the required level in the final PCM composition.

The PCM additive(s) forming the kit component may be dissolved or suspended in the latent heat storage material in a liquid form. The PCM additive(s) forming the kit component may be dissolved or suspended in the latent heat storage material in a concentration higher than that required in the final PCM composition, and then the kit component used by combination with the latent heat storage material to bring the concentration of the PCM additive down to the required level.

Thus the kit component(s), where they are blended with the latent heat storage material as a composite compressed and/or melt-cast piece, or are dissolved or suspended in the latent heat storage material, may be considered to be an additive concentrate, or additive concentrated form of the PCM which is to be produced by the use of the kit. Herein an additive concentrate is defined as a component which has a higher additive concentration which can be diluted with the latent heat storage material to produce the PCM.

The kit components may be more than 2×, more than 5×, more than 10×, more than 50×, more than 100×, more than 200× or more than 500× more concentrated within the kit component than is required in the final PCM composition.

The latent heat storage material may be used to produce more than a 1 in 2 dilution, more than a 1 in 5 dilution, more than a 1 in 10 dilution, more than a 1 in 50 dilution, more than a 1 in 100 dilution, more than a 1 in 200 dilution or more than a 1 in 500 dilution factor to produce the final PCM.

One or more latent heat storage material precursor(s) may also be used to provide such a dilution factor.

Various non-limiting embodiments of the kit components and the class of latent heat storage materials with which they may be combined to produce a PCM are given in Table 3.

TABLE 3

| Class of | | | |
|---|---|---|---|
| latent heat | | Kit | Preferred |
| storage | | Component(s) | Form |
| material | Kit Component(s) | Purpose | in the Kit |
| Salt | Polymers | Stabilising | Solution, |
| Hydrates | | Agent | suspension |
| (e.g. Mₜⁿ⁺Xᵣ^{y-} · | | | and/or |
| zH₂O | | | compressed |
| where M = | | | and/or |
| cation and | | | melt-cast |
| X = anion, | | | solid |
| z = hydration | Copolymers | Stabilising | Solution, |
| number, n | | Agent | suspension |
| and y = | | | and/or |
| integers and | | | compressed |
| t × n = r × y) | | | and/or |
| | | | melt-cast |
| | | | solid |
| | Surfactants | Stabilising | Solution, |
| | | Agent | suspension |
| | | | and/or |
| | | | compressed |
| | | | and/or |
| | | | melt-cast |
| | | | solid |
| | Metal oxides | Nucleation | Compressed |
| | | Agent | solid and/or |
| | | | suspension |
| | Metal carbides | Nucleation | Compressed |
| | | Agent | solid and/or |
| | | | suspension |
| | Metal silicates | Nucleation | Compressed |
| | | Agent | solid and/or |
| | | | suspension |
| | Phyllosilicates | Nucleation | Compressed |
| | | Agent | solid and/or |
| | | | suspension |
| | Thickeners | Stabilising | Solution |
| | | Agent | and/or |
| | | | compressed |
| | | | solid |
| | Surface coating agents | Anti-corrosion | Solution, |
| | | agent | suspension |
| | | | and/or |
| | | | compressed |
| | | | and/or |
| | | | melt-cast |
| | | | solid |
| | Acids (H⁺_{w}X^{y-}, where | pH modification | Solution |
| | w = y) | agent | and/or |
| | | | neat |
| | Bases (Mⁿ⁺(OH)ᵤ, | pH modification | Solution, |
| | where u = n) | agent | suspension |
| | | | and/or |
| | | | compressed |
| | | | and/or |
| | | | melt-cast |
| | | | solid |
| | Salt hydrates | Nucleation | Solution, |
| | (comprising | agent and/or | suspension |
| | either Mₜⁿ⁺ | melting point | and/or |
| | | | compressed |
| | or Xᵣ^{y-}, but | depression | and/or |
| | not both) | agent | melt-cast |
| | | | solid |
| | Salt hydrates | Nucleation | Solution, |
| | (comprising | agent and/or | suspension |
| | either Mₜⁿ⁺ | melting point | and/or |
| | or Xᵣ^{y-}, but | depression | compressed |
| | not both) | agent | and/or |
| | | | melt-cast |
| | | | solid |
| | 2D nanomaterials incl. | Thermal | Suspension |
| | carbonaceous | conductivity | and/or |
| | materials (e.g. | enhancing | compressed |
| | graphite) | agent | solid |
| | Biocides | Microbe | Solution |
| | | control | and/or |
| | | | compressed |
| | | | solid |
| Salt-water | Metal oxides | Nucleation | Compressed |
| eutectics | | Agent | solid and/or |
| | | | suspension |
| | Metal carbides | Nucleation | Compressed |
| | | Agent | solid and/or |
| | | | suspension |
| | Metal silicates | Nucleation | Compressed |
| | | Agent | solid and/or |
| | | | suspension |
| | Phyllosilicates | Nucleation | Compressed |
| | | Agent | solid and/or |
| | | | suspension |
| | Thickeners | Stabilising | Solution |
| | | Agent | and/or |
| | | | compressed |
| | | | solid |
| | Surface coating agents | Anti-corrosion | Solution, |
| | | agent | suspension |
| | | | and/or |
| | | | compressed |
| | | | and/or |
| | | | melt-cast |
| | | | solid |
| | Acids (H⁺_{w}X^{y-}, where | pH modification | Solution |
| | w = y) | agent | and/or neat |
| | Bases (Mⁿ⁺(OH)ᵤ, | pH modification | Solution, |
| | where u = n) | agent | suspension |
| | | | and/or |
| | | | compressed |
| | | | and/or |
| | | | melt-cast |
| | | | solid |
| | Salts | Nucleation | Solution, |
| | (comprising either | agent and/or | suspension |
| | Mₜⁿ⁺ or Xᵣ^{y-}, but not | melting point | and/or |
| | both) | depression | compressed |
| | | agent | and/or |
| | | | melt-cast |
| | | | solid |
| | Salt hydrates | Nucleation | Solution, |
| | (comprising | agent and/or | suspension |
| | either Mₜⁿ⁺ | melting point | and/or |
| | or Xᵣ^{y-}, but | depression | compressed |
| | not both) | agent | and/or |
| | | | melt-cast |
| | | | solid |
| | 2D nanomaterials incl. | Thermal | Suspension |
| | carbonaceous | conductivity | and/or |
| | materials (e.g. | enhancing | compressed |
| | graphite) | agent | solid |
| | Biocides | Microbe | Solution |
| | | control | and/or |
| | | | compressed |
| | | | solid |
| Organics (e.g. | Polymers | Crystal | Neat liquid, |
| paraffins, | | habit/growth | suspension, |
| esters, | | modulating | compressed |
| organic | | agent | and/or |
| acids) | | | melt-cast |
| | | | solid |
| | Copolymers | Crystal | Neat liquid, |
| | | habit/growth | suspension, |
| | | modulating | compressed |
| | | agent | and/or |
| | | | melt-cast |
| | | | solid |
| | Surfactants | Crystal | Neat liquid, |
| | | habit/growth | suspension, |
| | | modulating | compressed |
| | | agent | and/or |
| | | | melt-cast |
| | | | solid |
| | Metal oxides | Nucleation | Compressed |
| | | Agent | solid and/or |
| | | | suspension |
| | Metal carbides | Nucleation | Compressed |
| | | Agent | solid and/or |
| | | | suspension |
| | Metal silicates | Nucleation | Compressed |
| | | Agent | solid and/or |
| | | | suspension |
| | Phyllosilicates | Nucleation | Compressed |
| | | Agent | solid and/or |
| | | | suspension |
| | 2D nanomaterials incl. | Thermal | Suspension |
| | carbonaceous | conductivity | and/or |
| | materials (e.g. | enhancing | compressed |
| | graphite) | agent | solid |
| | Organic (of | Melting point | Neat liquid, |
| | a different | depression | suspension |
| | chemical | agent | and/or |
| | identity to | | compressed |
| | the latent | | and/or |
| | heat storage | | melt-cast |
| | material | | solid |
| | organic) | | |

Furthermore, specific and non-limiting embodiments of the kit components and the latent heat storage material with which they may be combined to produce a PCM are given in Table 4.

TABLE 4

| Latent | | | |
|---|---|---|---|
| Heat | | Kit | |
| Storage | | Component(s) | Preferred Form in |
| Material | Kit Component(s) | Purpose | the Kit |
| Sodium | Mono-, di-, | Nucleation | Solution, suspension |
| acetate | and/or | agent | and/or compressed |
| trihydrate | tri-sodium | | and/or melt-cast |
| | phosphate | | solid |
| | and/or | | |
| | pyrophosphate | | |
| | and/or | | |
| | tetrasodium | | |
| | pyrophosphate | | |
| | and/or any | | |
| | hydrate form | | |
| | thereof | | |
| Sodium | Polymers of | Stabilising | Solution, suspension |
| acetate | acrylic, | agent | and/or compressed |
| trihydrate | methacrylic | | and/or melt-cast |
| | and/or maleic | | solid |
| | acid, and/or | | |
| | copolymers | | |
| | and/or salts | | |
| | thereof | | |
| Sodium | Sodium salts | Melting point | Solution, suspension |
| acetate | of carboxylic | depression | and/or compressed |
| trihydrate | acids aside | agent | and/or melt-cast |
| | from acid, | | solid |
| | sodium nitrate, | | |
| | group I metal | | |
| | salts o facetic | | |
| | acid, metal | | |
| | acetates | | |
| | and/or any | | |
| | hydrate | | |
| | forms | | |
| | thereof | | |
| Sodium | Graphite, | Thermal | Suspension and/or |
| acetate | expanded | conductivity | compressed |
| trihydrate | natural | enhancing | |
| | graphite, | agent | |
| | hexagonal | | |
| | boron nitride | | |
| Sodium | Acetic acid, | pH modulating | Neat liquid, solution, |
| acetate | sodium | agent | suspension and/or |
| trihydrate | diacetate, | | compressed and/or |
| | acetic | | melt-cast solid |
| | anhydride or | | |
| | combination | | |
| | thereof | | |
| Sodium | Sodium | pH modulating | Solution, suspension |
| acetate | hydroxide | agent | and/or compressed |
| trihydrate | | | and/or melt-cast |
| | | | solid |
| | Phosphoric | pH modulating | |
| | acid | agent | |
| | Phosphate | pH modulating | |
| | salts | agent | |
| Calcium | Magnesium | Nucleation | Solution, suspension |
| nitrate | nitrate, | agents | and/or compressed |
| tetrahydrate | strontium | | and/or melt-cast |
| | nitrate | | solid |
| | and/or any | | |
| | hydrate | | |
| | form thereof | | |
| Calcium | Graphite, | Thermal | Suspension and/or |
| nitrate | expanded | conductivity | compressed and/or |
| tetrahydrate | natural | enhancing | melt-cast solid |
| | graphite, | agent | |
| | hexagonal | | |
| | boron nitride | | |
| Calcium | Calcium | pH modulating | Solution, suspension |
| nitrate | hydroxide | agent | and/or compressed |
| tetrahydrate | | | and/or melt-cast |
| | | | solid |
| Calcium | Nitric acid | pH modulating | Solution |
| nitrate | | agent | |
| tetrahydrate | | | |
| Calcium | Calcium | Melting point | Solution, suspension |
| nitrate | salts aside | depression | and/or compressed |
| tetrahydrate | from | agent | and/or melt-cast |
| | calcium | | solid |
| | nitrate | | |
| Calcium | Nitrate salts | Melting point | Solution, suspension |
| nitrate | aside from | depression | and/or compressed |
| tetrahydrate | calcium | agent | and/or melt-cast |
| | nitrate | | solid |
| Calcium | Biocides | Microbe | Solution and/or |
| nitrate | | control | compressed solid |
| tetrahydrate | | | |
| Water | Salts | Melting point | Solution, suspension |
| | and/or salt | depression | and/or compressed |
| | hydrates | agent | and/or melt-cast |
| | | | solid |
| Water | Graphite, | Thermal | Suspension and/or |
| | expanded | conductivity | compressed solid |
| | natural | enhancing | |
| | graphite, | agent | |
| | hexagonal | | |
| | boron nitride | | |
| Water | Metal oxides | Nucleation | Compressed solid |
| | | Agent | and/or suspension |
| Water | Metal | Nucleation | Compressed solid |
| | carbides | Agent | and/or suspension |
| Water | Metal | Nucleation | Compressed solid |
| | silicates | Agent | and/or suspension |
| Water | Phyllosilicates | Nucleation | Compressed solid |
| | | Agent | and/or suspension |
| Water | Acids (H⁺_{w}X^{y-}, | pH | Solution and/or neat |
| | where w = y) | modification | |
| | | agent | |
| Water | Bases (Mⁿ⁺(OH)ᵤ, | pH | Solution, suspension |
| | where u = n) | modification | and/or compressed |
| | | agent | and/or melt-cast |
| | | | solid |
| Water | Biocides | Microbe | Solution and/or |
| | | control | compressed solid |
| Magnesium | Magnesium | Melting point | Solution, suspension |
| nitrate | salts and/or | depression | and/or compressed |
| hexahydrate | magnesium | agent | and/or melt-cast |
| | salt hydrates | | solid |
| | aside from | | |
| | magnesium | | |
| | nitrate | | |
| Magnesium | Nitrate salts | Melting point | Solution, suspension |
| nitrate | and/or nitrate | depression | and/or compressed |
| hexahydrate | salt hydrates | agent | and/or melt-cast |
| | aside from | | solid |
| | magnesium | | |
| | nitrate | | |
| Magnesium | Graphite, | Thermal | Suspension and/or |
| nitrate | expanded | conductivity | compressed solid |
| hexahydrate | natural graphite, | enhancing | |
| | hexagonal | agent | |
| | boron nitride | | |
| Calcium | Chloride salts | Melting point | Solution, suspension |
| chloride | and/or hydrate | depression | and/or compressed |
| hexahydrate | forms thereof | agent | and/or melt-cast |
| | aside from | | solid |
| | calcium chloride | | |
| Calcium | Calcium salts | Melting point | Solution, suspension |
| chloride | and/or hydrate | depression | and/or compressed |
| hexahydrate | forms thereof | agent | and/or melt-cast |
| | aside from | | solid |
| | calcium chloride | | |
| Calcium | Potassium | Nucleation | Solution, suspension |
| chloride | chloride, | Agent | and/or compressed |
| hexahydrate | sodium chloride, | | and/or melt-cast |
| | strontium | | solid |
| | chloride | | |
| | and/or any | | |
| | hydrate | | |
| | form thereof | | |
| Calcium | Graphite, | Thermal | Suspension and/or |
| chloride | expanded | conductivity | compressed solid |
| hexahydrate | natural | enhancing | |
| | graphite, | agent | |
| | hexagonal | | |
| | boron nitride | | |
| Erythritol | Graphite, | Thermal | Suspension and/or |
| | expanded | conductivity | compressed solid |
| | natural graphite, | enhancing | |
| | hexagonal | agent | |
| | boron nitride | | |
| Erythritol | Sugar alcohols | Melting point | Compressed and/or |
| | and/or other | depression | melt-cast solid |
| | polyols other | agent | |
| | than erythritol | | |

A further disclosure as part of the present invention is a method of manufacturing a PCM. The method comprises:
providing a kit as disclosed herein;
providing a latent heat storage material; and
combining the kit components with the latent heat storage material.

Combining the kit (or kit components) and the latent heat storage material may comprise mixing or stirring the components and materials together. During and after the combination of the kit components with the latent heat storage material, optionally the components and/or the latent heat storage material and/or the mixture thereof may be stirred and/or heated. The mixture of the kit components and the latent heat storage material may be heated. The mixture may be heated during mixing and/or after mixing the materials.

The latent heat storage material and/or precursor thereof may preferentially be in the liquid phase. The latent heat storage material and/or precursor thereof may be heated to melt (i.e. the latent heat storage material may be in a molten state).

A further disclosure as part of the present invention is a method of manufacturing a PCM. The method comprises providing a kit as disclosed herein. The method then includes providing a precursor to a latent heat storage material. The precursor may be water and/or an acid or base.

The method may then comprise combining the kit components with the precursor to the PCM, and optionally adding of one or more of a salt, an acid where the precursor comprises a base; a base where the precursor comprises an acid and/or water. The method may then involve combining the kit and the precursor to a latent heat storage material to produce the PCM.

In this embodiment, the kit component(s) is/are combined with a precursor to the latent heat storage material, which may be an acid or base, to which a base or acid is added respectively to give the final PCM by neutralisation. The final PCM may be defined as the energy storage material which is to be used without further alterations. Thus, the bulk of the PCM (e.g. the bulk salt hydrate latent heat storage material) is formed by the neutralisation of the precursor, with the concurrent inclusion of the kit component(s).

The kit component(s) may also be added to the precursor water, to which is then added anhydrous salt and/or salt of a lower hydrate than that which is required in the final PCM. This results in the formation of the PCM from a precursor (in this case water) which is combined with the kit components and a solid (e.g. a salt and/or salt hydrate) to give the final PCM.

In a preferred embodiment of the present invention, the liquid PCM precursor may be water, and the PCM is produced by combination of the PCM precursor with the kit components and a salt.

In a further preferred embodiment of the present invention, the liquid PCM precursor may be an acid, and the PCM is produced by combination of the PCM precursor with the kit components and a base.

In a further preferred embodiment of the present invention, the liquid PCM precursor may be a base, and the PCM is produced by combination of the PCM precursor with the kit components and an acid.

Use of a kit as disclosed herein comprises a way by which the preparation of a PCM may be reduced in complexity. Where operators are non-technical, it is preferable to avoid the need for precise weighing and measuring, and having macroscopic, form stabilised additive pieces or liquid volumes which may be added simplifies and quickens the process considerably. In this scenario, rather than weighing additives in the correct ratios to each other and the latent heat storage material bulk, the PCM can be produced simply by counting compressed additive pieces.

Preparation of PCM samples using compressed additive pieces and/or additives in a liquid state also reduces the risk of hazardous dust formation or splashing. A further advantage of this method is to decouple the production of the PCM additive from the production of the overall PCM composition. Thus, the small scale and bulk preparation processes can be done at different times, reducing complexity and building resilience into the overall production process. The nucleation agent, typically in a low loading at potentially high cost and subject to careful tolerances, can thereby be prepared separately to the bulk latent heat storage material. This allows additives to be prepared at a convenient time with good accuracy and used when needed, adding to the flexibility of the production process.

It is disclosed herein that the kit components may be dispersed in the (e.g. liquid) latent heat storage material by agitation, melting, abrasion, dissolution, dilution, gas evolution, phase transition, photochemical degradation or combination thereof.

It is advantageous for the deskilling of the preparation method of a PCM using a kit as defined herein that any solid components (i.e. the compressed and/or melt-cast components) are sized such that an integer number of pieces may be used to produce the PCM. By this method, a slow measurement (weighing) is replaced by a simple and rapid counting process.

In a further aspect of the present invention is disclosed a method manufacturing a PCM, the method comprising combining a kit component(s) as described herein with other PCM components (i.e. the latent heat storage material) within a thermal energy storage device. A thermal energy storage device may be known as a heat or thermal store, bank, battery, buffer or reservoir.

A thermal energy storage device may comprise one or more containers, within which may be any one or more of the following:
one or more heat exchangers;
one or more heat sources;
one or more sources of cooling; and/or
one or more ports via which material may be added or removed from the device.

A thermal energy storage device may also comprise thermal insulation, sensors and control electronics and/or means of mixing the PCM.

A thermal energy storage device may also comprise an arrangement for adding materials to the container which comprises said device. This may be a funnel, pipe, canula, port or other means, which may be removable from the device after use. Said arrangement for adding materials to the thermal energy storage device container may also be a housing within which the kit components may be placed during preparation.

The kit as disclosed herein may be used by locating the kit component(s) within the thermal energy storage device and then addition of the remaining PCM component(s). Herein the remaining kit component(s) may comprise the latent heat storage material.

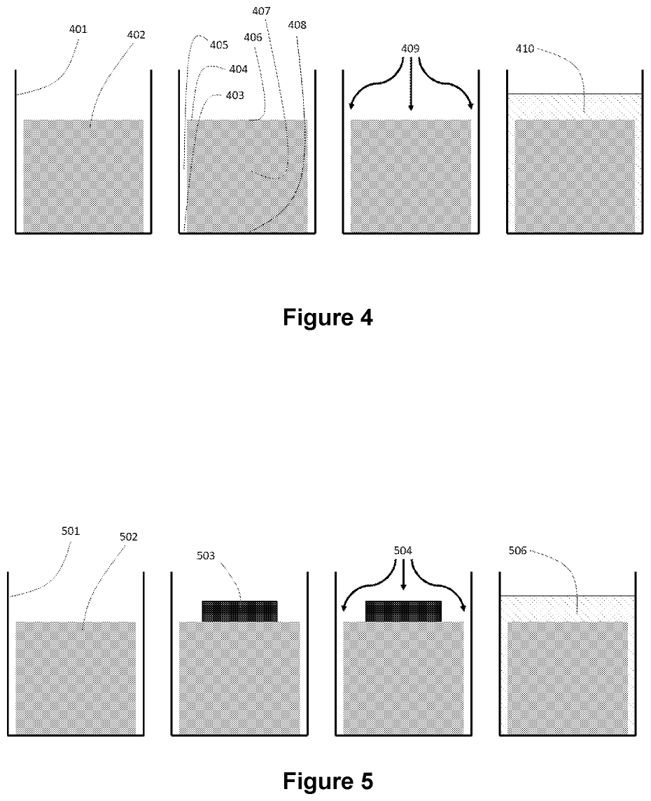

For example, FIG. 4 shows various positions in which the kit components may be located within a heat battery enclosure (401) comprising, for example, an internal heat battery componentry (402) such as a heat exchanger. The kit components may be applied in various locations before combination with the other PCM components or precursor(s) thereof. For example, the kit component(s) may be located at the base of the heat battery apparatus against the container wall (403), at a point on the container walls (405) and/or on top of any heat battery components near the container walls (404).

The kit components may also be located at the base of the heat battery containment in the centre of the heat battery (408), within the core of any internal heat battery componentry (407) such as a heat exchanger, or on top of any heat battery componentry (406). Once located within the heat battery containment and/or on the surface of any internal heat battery componentry, the other PCM components or any precursors thereof may be introduced into the heat battery container (409) to give the PCM (410) comprising the PCM additives which formed the kit components. Where kit components are liquid, locating said components anywhere other than the base of the heat battery requires a sufficient open volume to be present in the internal componentry's (402) structure, without said volume available, liquid components will preferentially flow downward to occupy the base of the heat battery until combined with the other PCM components.

The kit component(s) may be used by locating the component(s) within the thermal energy storage device container and/or may be located in contact with one or more of the apparatus' which comprise the thermal energy storage device, before combination with the remaining kit component(s).

The kit component(s) preferentially may be used by locating the component(s) in contact with one or more heat exchanger supplying heat and/or one or more heat source. It is a preferred embodiment of the present invention that the kit component(s) be located in contact with one or more heat source, which may be a heat exchanger supplying heat, and that said heat source is used to apply heat to the kit component(s) before and during the addition of the remaining PCM component(s).

The latent heat storage material may be combined with the kit component(s) as a liquid (i.e. in a molten state).

The kit component(s) preferentially may be used by locating the component(s) in the path of the latent heat storage material as it is added into the thermal energy storage device, such that the liquid latent heat storage material is impinging on the surface of the kit component(s) during their combination.

A method of manufacturing a PCM using of the kit as described herein is shown schematically in FIG. 5. In FIG. 5, the heat battery containment (501) containing internal apparatus to allow the use of the heat battery (502) is used as a stage upon which to locate the kit components (503). The kit components are then combined with the other PCM components (i.e. the latent heat storage material or precursor(s) thereof) by flowing the other PCM components over the surface of the kit components according to (504) to give the PCM (506) within the heat battery apparatus.

The kit component(s) may be used by locating the component(s) on the upper surface of one or more heat exchangers, and then combining with the remaining PCM components by flowing the remaining PCM components over the kit component(s) and into the PCM container.

Table 4 shows various examples of methods by which the kit as described herein may be used.

TABLE 4

| Latent Heat | |
|---|---|
| Storage Material | Method of kit use to form the PCM |
| Metal acetate | Combination of the kit component(s) with water, |
| hydrate | followed by addition of the anhydrous form of |
| | the metal acetate and/or a form of the metal acetate |
| | with a lower hydration number than what is desired |
| | in the final PCM. |
| Metal acetate | Combination of the kit component(s) with acetic |
| hydrate | acid and/or acetic anhydride followed by addition |
| | of a basic form of the metal and water. |
| Metal acetate | Combination of the kit component(s) with a basic |
| hydrate | form of the metal, a solution thereof and/or the |
| | metal itself, followed by addition of acetic acid |
| | and/or acetic anhydride and optionally water. |
| Metal acetate | Combination of the kit component(s) with the |
| hydrate | anhydrous form of the metal acetate, followed by |
| | addition of water. |
| Metal acetate | Combination of the kit component(s) with molten |
| hydrate | metal acetate hydrate. |
| Metal nitrate salt | Combination of the kit component(s) with water, |
| hydrates | followed by addition of the anhydrous form of the |
| | metal nitrate and/or a form of the metal nitrate with |
| | a lower hydration number than what is desired in |
| | the final PCM. |
| Metal nitrate salt | Combination of the kit component(s) with nitric |
| hydrates | acid, followed by addition of a basic form of the |
| | metal and water. |
| Metal nitrate salt | Combination of the kit component(s) with a basic |
| hydrates | form of the metal, a solution thereof and/or the |
| | metal itself, followed by addition of nitric acid |
| | and optionally water. |
| Metal nitrate salt | Combination of the kit component(s) with the |
| hydrates | anhydrous form of the metal nitrate, followed |
| | by addition of water. |
| Metal nitrate salt | Combination of the kit component(s) with molten |
| hydrates | metal nitrate hydrate. |
| Metal chloride | Combination of the kit component(s) with water, |
| salt hydrate | followed by addition of the anhydrous form of |
| | the chloride and/or a form of the metal chloride |
| | with a lower hydration number than what is |
| | desired in the final PCM. |
| Metal chloride | Combination of the kit component(s) with |
| salt hydrate | hydrochloric acid, followed by addition of a basic |
| | form of the metal and water. |
| Metal chloride | Combination of the kit component(s) with a basic |
| salt hydrate | form of the metal, a solution thereof and/or the |
| | metal itself, followed by addition of hydrochloric |
| | acid and optionally water. |
| Metal chloride | Combination of the kit component(s) with the |
| salt hydrate | anhydrous form of the metal chloride, followed |
| | by addition of water. |
| Metal chloride | Combination of the kit component(s) with |
| salt hydrate | molten metal chloride hydrate. |
| Metal bromide | Combination of the kit component(s) with water, |
| hydrate | followed by addition of the anhydrous form of |
| | the bromide and/or a form of the metal bromide |
| | with a lower hydration number than what is |
| | desired in the final PCM. |
| Metal bromide | Combination of the kit component(s) with |
| hydrate | hydrobromic acid, followed by addition of a |
| | basic form of the metal and water. |
| Metal bromide | Combination of the kit component(s) with a |
| hydrate | basic form of the metal, a solution thereof |
| | and/or the metal itself, followed by addition of |
| | hydrobromic acid and optionally water. |
| Metal bromide | Combination of the kit component(s) with the |
| hydrate | anhydrous form of the metal bromide, followed |
| | by addition of water. |
| Metal bromide | Combination of the kit component(s) with |
| hydrate | molten metal bromide hydrate. |
| Metal sulfate | Combination of the kit component(s) with water, |
| hydrate | followed by addition of the anhydrous form of |
| | the sulfate and/or a form of the metal sulfate |
| | with a lower hydration number than what is |
| | desired in the final PCM. |
| Metal sulfate | Combination of the kit component(s) with sulfuric |
| hydrate | acid, followed by addition of a basic form of the |
| | metal and water. |
| Metal sulfate | Combination of the kit component(s) with a basic |
| hydrate | form of the metal, a solution thereof and/or the |
| | metal itself, followed by addition of sulfuric acid |
| | and optionally water. |
| Metal sulfate | Combination of the kit component(s) with the |
| hydrate | anhydrous form of the metal sulfate, followed by |
| | addition of water. |
| Metal sulfate | Combination of the kit component(s) with molten |
| hydrate | metal sulfate hydrate. |
| Metal carbonate | Combination of the kit component(s) with water, |
| hydrate | followed by addition of the anhydrous form of |
| | the metal carbonate and/or a form of the metal |
| | carbonate with a lower hydration number than |
| | what is desired in the final PCM. |
| Metal carbonate | Combination of the kit component(s) with the |
| hydrate | anhydrous form of the metal carbonate, followed |
| | by addition of water. |
| Metal carbonate | Combination of the kit component(s) with |
| hydrate | molten metal carbonate hydrate. |
| Salt-water | Combination of the kit component(s) with water, |
| eutectic | optionally followed by addition of the anhydrous |
| | form of the salt, and/or an acid/base combination |
| | which produces the desired salt. |
| Salt-water | Combination of the kit component(s) with an acid, |
| eutectic | followed by addition of a base to produce the |
| | desired salt, with the optional addition of water. |
| Salt-water | Combination of the kit component(s) with a base, |
| eutectic | followed by addition of an acid to produce the |
| | desired salt, with the optional addition of water. |
| Salt-water | Combination of the kit component(s) with the |
| eutectic | anhydrous form of the salt and then addition of |
| | water. |
| Salt-water | Combination of the kit component(s) with the |
| eutectic | molten salt-water eutectic. |

The methods described in Table 4 may also be carried out within a heat battery apparatus.

### EXAMPLES

### Example 1

A kit for production of a PCM comprising the latent heat storage material calcium nitrate tetrahydrate was prepared, comprising the nucleation agents magnesium nitrate and strontium nitrate in the form of a melt-cast piece. The melt-cast piece comprised:
strontium nitrate (50 wt. %); and
magnesium nitrate hexahydrate (50 wt. %)

The melt-cast piece was prepared as follows:

The magnesium nitrate hexahydrate was firstly heated to a temperature above 89° C. and then combined with strontium nitrate. The mixture was stirred or otherwise agitated before pouring into a mould and leaving to cool to ambient temperature and solidify.

The kit comprising said melt-cast piece was then used by combination with molten calcium nitrate tetrahydrate (above about 43° C.) such that the final concentration of strontium nitrate and magnesium nitrate hexahydrate were about 0.4 wt. % each. The mixture was stirred to dissolve and disperse the melt-cast additive piece.

### Example 2

A kit for production of a PCM comprising the latent heat storage material sodium acetate trihydrate was prepared, wherein the kit comprised the nucleation agent disodium phosphate dihydrate as a compressed piece and the stabilisation agent sodium polymethacrylate as a liquid solution.

The nucleation agent was compressed into discs of about 5 cm diameter and 1 cm height with a pressure of about 10 MPa. The sodium polymethacrylate was dissolved in water to a concentration of about 40 wt. %. These two parts comprised the kit components.

The kit was then used by addition of the two kit components to water heated to above 58° C., followed by the addition of sodium acetate anhydrous to give a PCM with the composition of about:
97 wt. % sodium acetate trihydrate;
2 wt. % disodium phosphate dihydrate; and
1 wt. % sodium polymethacrylate.

The PCM was then mixed while maintaining the temperature above about 58° C. until the two additive components originating from the kit were fully dissolved and dispersed.

### Example 3

A kit for production of a PCM comprising the latent heat storage material calcium chloride hexahydrate, where the kit comprises the nucleation agent additives potassium chloride, sodium chloride and strontium chloride hexahydrate.

The potassium and sodium chlorides compressed into a piece by blending the two solids in a 80:20 mass ratio and compressing into cubes with a pressure of approx. 25 MPa.

The strontium chloride hexahydrate was formed into a melt-cast piece by heating the solid to above about 61° C., pouring the material into a mould and allowing to cool to room temperature to solidify.

These two solid pieces comprised the PCM kit components.

The kit was then used by addition of each component to water above about 28° C. and then calcium chloride dihydrate was added such that the overall composition of the PCM was about:
47 wt. % calcium chloride;
46 wt. % water;
4 wt. % potassium chloride;
1 wt. % sodium chloride; and
2 wt. % strontium chloride hexahydrate.

The PCM was then mixed while maintaining the temperature above about 28° C. until the two additive components originating from the kit were fully dissolved and dispersed.

### Example 4

A kit for production of a PCM comprising a salt-water eutectic latent heat storage material, where the kit comprises:
the melting point depression agent magnesium sulfate in a compressed form;
the nucleation agent additive silver iodide in a compressed form; and
the nucleation agent silicon dioxide in a compressed form.

Each of the PCM additives were compressed into discs of approximately 10 cm diameter and 2 cm height with a pressure of approximately 100 MPa. These discs comprised the kit for production of the PCM.

To form the PCM, the kit was used as follows. The compressed disc comprising magnesium sulfate was first added to water in an amount such that the magnesium sulfate mass loading was about 19 wt. %, and the mixture stirred. The discs of silver iodide and silicone dioxide were then added such that their concentrations in the final mixture were approximately 0.1 wt. % and 1 wt. % respectively.

### Example 5

A kit for production of a PCM comprising the latent heat storage material magnesium nitrate hexahydrate, where the kit comprised:
the melting point depression agent lithium nitrate trihydrate; and
the anti-corrosion agent benzotriazole.

The kit was comprised of a single component, formed by blending approximately 0.08 wt. % benzotriazole into molten lithium nitrate trihydrate above its melting point of 30° C. This mixture was allowed to freeze in a mould.

The kit was then used by melting the kit component by heating it to above its melting point (30° C.) and combining the molten kit component with molten magnesium nitrate hexahydrate at a temperature above 89° C. and mixing to disperse.

### Example 6

A kit for production of a PCM comprising the latent heat storage material magnesium nitrate hexahydrate, where the kit comprises:
about 10 wt. % expanded natural graphite as a thermal conductivity enhancing agent suspended in the stabilisation agent poloxamer 407.

The kit was used by combining the suspension with molten magnesium nitrate hexahydrate at a temperature above 89° C. and mixing to disperse.

### Example 7

A kit for production of a PCM comprising the latent heat storage material sodium acetate trihydrate was prepared, wherein the kit comprises:
a liquid component comprising disodium phosphate (5 wt. %) and sodium polyacrylate (40 wt. %) dissolved in water (55 wt. %);
a compressed solid component comprising disodium phosphate dihydrate and
a second liquid component comprising the pH modification agent acetic acid.

The kit was then used by addition of the kit components to water heated to above 58° C., followed by the addition of sodium acetate anhydrous to give a PCM with the composition of about:
96.8 wt. % sodium acetate trihydrate;
2 wt. % disodium phosphate dihydrate;
1 wt. % sodium polymethacrylate, and
0.2 wt. % acetic acid.

The PCM was then mixed while maintaining the temperature above about 58° C. until the PCM additive components originating from the kit were fully dissolved and dispersed.

### Example 8

A kit for production of a PCM comprising the latent heat storage material sodium acetate trihydrate was prepared, wherein the kit comprises:
a compressed solid piece comprising alternating layers of disodium phosphate (67 wt. %); and
sodium polyacrylate (33 wt. %);
wherein the piece was a disc of approximately 5 cm in diameter and 3 cm in height, and the layers were approximately 0.2 cm in height.

The disc was prepared by adding alternating layers of disodium phosphate and sodium polyacrylate solids into a cylindrical die with an internal diameter of 5 cm, and compressing to about 150 MPa between additions of each material. This composite compressed disc of additives comprised the kit component.

The kit was then used by combination of the compressed disc with a liquid PCM precursor solution of sodium hydroxide (52 wt. %) in water, with stirring to dissolve and disperse the kit components.

To this mixture was then added acetic acid, until the PCM final composition was:
about 97 wt. % sodium acetate trihydrate;
about 2 wt. % disodium phosphate dihydrate; and
about 1 wt. % sodium polymethacrylate.

The mixture is maintained above 58° C.

### Example 9

A kit for production of a PCM comprising the latent heat storage material calcium nitrate tetrahydrate, wherein the kit comprises:
a single liquid component comprising the nucleation agents magnesium nitrate and strontium nitrate dissolved in nitric acid.

The composition of the liquid was:
about 10 wt. % magnesium nitrate hexahydrate;
about 10 wt. % strontium nitrate;
about 54 wt. % nitric acid; and
about 26 wt. % water

The kit was then used by pouring the kit component into a mixing vessel and adding in order:
water;
calcium carbonate anhydrous; and
calcium nitrate anhydrous;
until the final composition was:
   about 1 wt. % strontium nitrate;
   about 1 wt. % magnesium nitrate hexahydrate; and
   about 98 wt. % calcium nitrate tetrahydrate.

During the addition of the calcium carbonate to the diluted kit component mixing was achieved using the gas evolution caused by the combination of the acid and metal carbonate. This also produced heat which aided in the production of a fully liquid PCM sample which could be easily transferred into a secondary receptacle such as a heat battery.

### Example 10

A kit for production of a PCM comprising a salt-water eutectic latent heat storage material, where the kit comprises:
the melting point depression agent magnesium nitrate in a compressed form;
the nucleation agent additive silicon carbide in a compressed form;
and the nucleation agent silicon dioxide in a compressed form.

Each of the PCM additives were compressed into discs of approximately 10 cm diameter and 2 cm height with a pressure of approximately 25 MPa. These discs comprised the kit for production of the PCM.

The kit components were then used by addition of each compressed piece into a heat battery apparatus comprising a containment vessel within which was situated a heat exchanger. The discs were placed on top of said heat exchanger, directly below a port through which material may be added to the containment vessel.

Through this port was then added the latent heat storage material (water), which flowed over the compressed disc surfaces, thereby dissolving/dispersing the materials throughout the PCM. Water was added until the final PCM composition was:
about 30 wt. % magnesium nitrate;
about 2 wt. % silicon carbide;
about 2 wt. % silicon dioxide; and
about 66 wt. % water.

### Example 11

A kit for production of a PCM comprising the latent heat storage material magnesium nitrate hexahydrate, where the kit comprises:
the melting point depression agent lithium nitrate trihydrate;
expanded natural graphite as a thermal conductivity enhancement agent;
and
the anti-corrosion agent benzotriazole.

The kit was comprised of a single component, formed by blending approximately 0.08 wt. % benzotriazole and approximately 5 wt. % expanded natural graphite into molten lithium nitrate trihydrate above its melting point of 30° C. This composition was mixed until homogeneous and then used as follows.

The kit component was transferred to a heat battery apparatus, wherein the heat battery comprised a containment vessel within which was a heating element situated at the bottom of the containment vessel and a heat exchanger arranged above. The kit component was poured into the containment vessel, such that it flowed downwards and occupied the space around the heating element.

The kit component was then allowed to freeze.

The latent heat storage material magnesium nitrate hexahydrate was then added to the heat battery containment as a molten liquid (i.e. above about 89° C.).

It was found that to improve the dispersion of the kit components throughout the PCM that the electric heating element can be activated before addition of the molten latent heat storage material, resulting in the kit component being also in a liquid state before combination with the latent heat storage material.

### Example 12

A kit for production of a PCM comprising the latent heat storage material dimethyl adipate, where the kit comprises the nucleation agents titanium dioxide and silicone dioxide suspended in dimethyl adipate, such that the kit component had the overall composition of about:
25 wt. % titanium dioxide;
25 wt. % silicon dioxide; and
50 wt. % dimethyl adipate.

This suspension comprised the singular kit component.

This kit component can be considered to be a concentrated form of the PCM.

To use, the kit component was combined with the latent heat storage material dimethyl adipate to dilute the nucleation agents such that the final PCM composition was about:
0.5 wt. % titanium dioxide
0.5 wt. % silicon dioxide
99 wt. % dimethyl adipate.

### Example 13

A kit for the production of a PCM comprising the latent heat storage material calcium nitrate tetrahydrate, where the kit comprises the nucleation agents magnesium nitrate and strontium nitrate in the form of a melt-cast piece. The melt-cast piece comprised:
strontium nitrate (50 wt. %); and
magnesium nitrate hexahydrate (50 wt. %).

The melt-cast piece was prepared as follows. The magnesium nitrate hexahydrate was firstly to above 89° C. and combining with strontium nitrate. The mixture was mixed before pouring into a mould and leaving to cool to ambient and solidify.

The kit was then used as follows. One or more melt-cast piece(s) were then added into a 50 wt. % solution of calcium nitrate at room temperature such that the loading of magnesium nitrate hexahydrate and strontium nitrate were about 1.5 wt. %. The mixture was then stirred and heated to above about 43° C. Anhydrous calcium nitrate was then added to bring the calcium nitrate concentration to about 70 wt. %.

Many modifications and other embodiments of the disclosure will come to mind to one skilled in the art to which this disclosure pertains having the benefit of the teachings presented in the foregoing description; and it will be apparent to those skilled in the art that variations and modifications of the present disclosure can be made without departing from the scope of the appended claims. Therefore, it is to be understood that the disclosure is not to be limited to the specific embodiments disclosed and that modifications and other embodiments are intended to be included within the scope of the appended claims.

1. A kit for producing a phase change material (PCM), wherein the kit comprises:
at least one or a plurality of PCM additive components, wherein:
the at least one or plurality of PCM additive components is:
in a compressed form;
in a melt-cast form;
and/or
in a liquid or suspension form,
wherein the kit is configured to be used by combining the at least one or the plurality of PCM additive components with a latent heat storage material and/or precursor thereof to produce the PCM, and wherein combining the kit and the latent heat storage material comprises dispersing, dissolving or suspending the kit components in the latent heat storage material by any suitable means,
wherein when the kit comprises the PCM additive component in a compressed form and/or in a melt-cast form, the PCM additive is supplied in the kit in the form of at least one compressed piece and/or melt-cast piece and wherein the at least one compressed piece and/or melt-cast piece has a volume of at least about 0.1 cm³.

2. A kit according to claim 1, wherein the at least one or a plurality of PCM additive components is selected from any one of or combination of the following:
nucleation agents;
stabilisation agents;
melting point depression agents;
anti-corrosion agents;
rheology modification agents;
pH modification agents;
thermal conductivity enhancing agents; and/or
biocides.

3. A kit according to claim 1, wherein the kit comprises at least one piece of PCM additive in a compressed solid form, or in a melt-cast solid form, and wherein the at least one compressed piece or melt-cast piece has a volume of one of at least about 1 cm³, at least about 100 cm³, at least about 500 cm³, at least about 1,000 cm³, at least about 5,000 cm³, or at least about 10,000 cm³.

4. A kit according to claim 1, wherein the compressed solid and/or melt-cast additive(s) is/are compressed and/or melt cast in one or more of the following geometries:
spherical;
cuboidal;
ellipsoidal;
cylindrical;
conical;
star;
any pyramidal shape;
any sheet like geometry,
any bar like geometry, and/or
any bipyramidal shape.

5. A kit according to claim 1, wherein the wherein the kit comprises at least one PCM additive piece in a compressed solid form, or in a melt-cast solid form and wherein the at least one PCM additive piece comprises a single additive or wherein the at least one PCM additive piece comprises a plurality of additives; or
wherein the kit comprises a plurality of compressed and/or melt-cast PCM additive pieces in a compressed solid form and/or in a melt-cast solid form, optionally wherein said pieces are uniform or substantially uniform in mass and/or dimension.

6. (canceled)

7. A kit according claim 1, wherein the PCM additive(s) is/are in a liquid or suspension form, and wherein;
the PCM additive(s) are a liquid and/or suspension under ambient conditions of temperature and pressure;
and/or
the PCM additive(s) have been dissolved or suspended in a solvent;
and/or
one or more additive(s) is/are dissolved or suspended in one or more other additives;
and/or
are liquefied by the application of heat, optionally wherein the one or more additive component(s) in a liquid form comprise the PCM additives fully dissolved in water; or, wherein one or more additive component(s) in a liquid form comprise the PCM additives saturated in water, or wherein one or more additive component(s) in a liquid form comprise a suspension of the PCM additives in water, or wherein one or more additive component(s) in a liquid form comprise a suspension of the PCM additives in water.

8. (canceled)

9. (canceled)

10. A kit according to claim 7, wherein one or more liquid component(s) comprise a mixture of one or more additives dissolved or suspended in one or more additives which is a liquid.

11. A kit according to claim 1, wherein the PCM additive component(s) is/are:
at least one compressed and/or melt-cast solid piece(s) with a volume of at least about 0.1 cm³; and
wherein any compressed pieces have been subject to a compression of at least about 1 MPa.

12. (canceled)

13. A kit according to claim 1, wherein one or a plurality of the kit component(s) comprise a mixture of the PCM additive(s) and a part of the latent heat storage material; and
wherein the kit component(s) are configured to be used by being combined with and diluted in further latent heat storage material or a precursor thereof.

14. A kit according to claim 1, wherein one of:
the PCM additive component is a nucleation agent selected from mono-, di-, and/or tri-sodium phosphate and/or pyrophosphate and/or tetrasodium pyrophosphate and/or any hydrate form thereof provided in solution, in suspension, in compressed form and/or in melt cast solid form, the kit further comprising sodium acetate trihydrate as latent heat storage material; or
the PCM additive component is a nucleation agent selected from magnesium nitrate, strontium nitrate and/or any hydrate form thereof provided in solution, in suspension, in compressed form and/or in melt cast solid form, the kit further comprising calcium nitrate trihydrate as latent heat storage material.

15. A method of using a kit according to claim 1 for the manufacture of a PCM:
a) Wherein the kit comprises a melt-cast piece comprising the nucleation agents strontium nitrate on a 50 wt % concentration and magnesium nitrate hexahydrate on a 50 wt % concentration, and the latent heat storage material is calcium nitrate tetrahydrate, such that the final concentration of strontium nitrate and magnesium nitrate hexahydrate are about 0.4 wt % each; or
b) Wherein the kit comprises the nucleation agent disodium phosphate dihydrate as a compressed piece and the stabilisation agent sodium polymethacrylate as a liquid solution, wherein the nucleation agent is compressed into discs of about 5 cm diameter and 1 cm height with a pressure of about 10 MPa and the sodium polymethacrylate is dissolved in water to a concentration of about 40 wt. %, and wherein the composition of the obtained PCM is about 97 wt % sodium acetate trihydrate as the latent heat storage material; 2 wt % disodium phosphate dihydrate; and 1 wt % sodium polymethacrylate.

16. A method of manufacturing a piece of a PCM additive in compressed form for use in a kit of according to claim 1, the method comprising:
disposing a loose powder comprising one or more PCM additive(s) within a pressure rated die and applying pressure to said pressure-rated die; and
optionally wherein the pressure is one of at least about 1 MPa, at least about 2.5 MPa; at least about 5 MPa; at least about 25 MPa; at least about 100 MPa, or at least about 250 MPa, wherein the PCM additive in compressed form is configured to be dispersed, dissolved or suspended in a latent heat storage material and/or precursor thereof by any suitable means to produce a PCM, and wherein the at least one compressed form of the additive is a piece having a volume of at least about 0.1 cm³.

17. A method of manufacturing a piece of a PCM additive according to claim 16, wherein one of:
the compression pressure is from about 1 MPa to about 25 MPa and the compressed PCM additive is configured to disperse into the latent heat storage material rapidly;
the compression pressure is at least about 25 MPa and the PCM additive is configured to disperse into the latent heat storage material slowly;
the compression pressure is applied uniaxially; or
the compression pressure is applied in 2, 3, or more axes.

18. A method of manufacturing a piece of a PCM additive in a melt-cast form for use in the kit of claim 1, the method comprising:
providing a solid comprising a PCM additive material or mixture of PCM additive materials;
melting the PCM additive material or materials;
disposing the molten additive material(s) in a mould or surface; and
allowing the PCM additive material(s) to cool and solidify in the mould or surface to give one or more piece(s), wherein the PCM additive in melt-cast form is configured to be dispersed in a latent heat storage material and/or precursor thereof by any suitable means to produce a PCM, and wherein the melt-cast form of the additive is a piece having a volume of at least about 0.1 cm³.

19. A method of manufacturing a piece of a PCM additive in a melt-cast form according to claim 18, wherein the PCM additive in melt-cast form comprises a mixture of PCM additive materials, the method comprising combining the loose solid forms of the PCM additive materials; and
optionally mixing and/or Heating the PCM additives to at least the melting point of one of the PCM additive materials; and/or
optionally mixing; and/or
cooling the PCM additive or additive composite to solidify.

20. A method manufacturing a phase change material, the method comprising:
providing a kit according to claim 1;
providing one or more latent heat storage material(s); and
dispersing, dissolving or suspending the kit components in the one or more latent heat storage material(s).

21. A method of manufacturing a phase change material according to claim 16, wherein the one or more latent heat storage material(s) is in liquid state; and
the method comprises dispersing, dissolving or suspending the kit components in the one or more liquid latent heat storage material(s).

22. A method of manufacturing a phase change material, the method comprising:
providing a kit according to claim 1;
providing a precursor to a latent heat storage material, wherein the precursor is:
water; and/or
an acid; and/or
a base; and
dissolving or suspending the kit components in the precursor to the latent heat storage material; and
adding any one or more of the following:
a salt; and/or
an acid where the precursor comprises a base; and/or
a base where the precursor comprises an acid; and/or,
water.

23. A method of manufacturing a phase change material according to claim 20, wherein one of:
the latent heat storage material and/or latent heat storage material precursor is/are provided in a liquid state by heating the latent heat storage material and/or latent heat storage material precursor prior to its combination with the kit component(s); or
wherein after dispersing, dissolving or suspending of the kit components in the latent heat storage material or latent heat storage material precursor, the mixture is agitated and/or heated; or
wherein an integer number of compressed additive pieces and/or melt-cast pieces is dispersed, dissolved or suspended in the latent heat storage material or latent heat storage material precursor; or wherein the vessel in which the kit component(s) is/are combined with the one or more latent heat storage material or liquid latent heat storage material precursor is a thermal energy storage device, wherein the thermal energy storage device comprises one or more containers, within which there is optionally housed any one or more of the following:
one or more heat exchangers;
one or more heat sources;
one or more sources of cooling; and/or
one or more ports via which material are optionally added or removed from the device; or
wherein the vessel in which the kit component(s) is/are combined with the one or more latent heat storage material or liquid latent heat storage material precursor is a thermal energy storage device, and the kit component(s) is/are located within the thermal energy storage device such that when the latent heat storage material or latent heat storage material precursor is added the kit component(s) is/are impinged upon by the latent heat storage material or latent heat storage material precursor.

24. (canceled)

25. (canceled)

26. (canceled)

27. (canceled)

28. A method of manufacturing a phase change material according to claim 20, comprising:
combining molten calcium nitrate tetrahydrate above about 43° C. with at least one melt cast additive piece, wherein the melt cast additive piece comprises nucleation agents strontium nitrate at a concentration of 50 wt % and magnesium nitrate hexahydrate at a concentration of 50 wt %; and
stirring the mixture to dissolve and disperse the melt-cast additive piece,
wherein the final concentration of strontium nitrate is about 0.4 wt. % and magnesium nitrate hexahydrate in the PCM is about 0.4 wt. %.
